(19) United States
(12) Patent Application Publication
(10) Pub. No.: US 2004/0208087 A1
(43) Pub. Date: Oct. 21, 2004

(54) Chronograph timepiece containing chronogeaph train wheel disposed in chronograph unit

(76) Inventors: Katsuyoshi Takizawa, Chiba-shi (JP); Mamoru Watanabe, Chiba-shi (JP); Shigeo Suzuki, Chiba-shi (JP); Takashi Takahashi, Chiba-shi (JP); Takeshi Tokoro, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/809,643

(22) Filed: Mar. 25, 2004

(30) Foreign Application Priority Data
Mar. 27, 2003 (JP) 2003-087286

(51) Int. Cl. G04F 7/00; G04F 8/00; G04F 10/00

(52) U.S. Cl. 368/110

(57) ABSTRACT

To realize a chronograph timepiece in which a manufacture and an assembly of a chronograph mechanism are easy. A chronograph timepiece of the invention contains a main plate, a front train wheel and an escapement/speed control device, and possesses a base unit having at least one of a self-winding device or a hand winging device, and a chronograph unit containing a second display mechanism, a second chronograph train wheel, a minute chronograph train wheel, and an hour chronograph train wheel. The chronograph unit is disposed in a dial side than the base unit. The base unit contains a 1st transmission wheel, i.e., second wheel & pinion, and a 2nd transmission wheel, i.e., minute driving wheel & pinion, which are rotated on the basis of a rotation of a movement barrel complete. The second chronograph train wheel is comprised so as to be rotated on the basis of a rotation of the 1st transmission wheel 138, and the minute chronograph train wheel and the hour chronograph train wheel are comprised so as to be rotated on the basis of a rotation of the 2nd transmission wheel.

### BACKGROUND OF THE INVENTION

1. Field of the Invention

The present invention relates to a chronograph timepiece containing a chronograph train wheel disposed in a chronograph unit. In particular, the invention relates to a chronograph timepiece comprised such that “hour”, “minute” and “second” are measured, and a chronograph measurement result is displayed respectively by a chronograph hour hand, a chronograph minute hand, and a chronograph second hand.

2. Description of the Prior Art

(1) Conventional 1st Type Chronograph Timepiece

(1.1) Front Train Wheel

Referring to FIG. 36-FIG. 41, in a conventional 1st type chronograph timepiece, a movement (machine body containing a drive section) 800 possesses a base unit 801 containing a front train wheel, a rear train wheel, a rocking device, a hand setting device, a self-winding device and/or a hand winding device and the like, and a chronograph unit 900 containing a chronograph mechanism, a calendar mechanism and the like. The base unit 801 has a main plate 802 constituting a base plate of the movement 800, a winding stem 808 rotatable with respect to the main plate 802 and provided so as to be movable in a axial direction, a front train wheel provided rotatably with respect to the main plate 802, a barrel bridge (not shown in the drawing), a train wheel bridge (not shown in the drawing), a balance bridge (not shown in the drawing), an escapement mechanism (escape wheel & pinion, pallet fork) (not shown in the drawing), and a speed control mechanism (balance with hairspring) (not shown in the drawing).

The front train wheel contains a movement barrel complete (not shown in the drawing), a center wheel & pinion (not shown in the drawing), a third wheel & pinion 836, and a second wheel & pinion 840. A mainspring (not shown in the drawing) is disposed in the movement barrel complete, and comprises a power source of the chronograph timepiece. The center wheel & pinion is rotated by a rotation of the movement barrel complete. The third wheel & pinion 836 is rotated by a rotation of the center wheel & pinion. The third wheel & pinion 836 contains a third pinion 836b, a third gear wheel (not shown in the drawing), and a third transmission pinion 836d. A minute driving wheel & pinion 832 contains a cannon pinion 832b, a minute driving wheel 832c, and a 2nd cannon pinion 832d. The third pinion 836b meshes with the minute gear wheel 832c. The minute driving wheel & pinion 832 is rotated by a rotation of the third wheel & pinion 836. A minute wheel (not shown in the drawing) is rotated by a rotation of the cannon pinion 832b. An hour wheel 848 is rotated by a rotation of the minute wheel. The second wheel & pinion 840 is rotated by a rotation of the third wheel & pinion 836. The second wheel & pinion 840 contains a 2nd second pinion 840d.

(1.2) Chronograph unit

The chronograph unit 900 has a chronograph main plate 902 constituting a base plate of the chronograph mechanism, a chronograph bridge 912 disposed to the chronograph main plate 902 in a side where a dial 904 exists, and a chronograph train wheel provided rotatably with respect to the chronograph main plate 902 and the chronograph bridge 912. A start/stop button 906 for controlling an operation and a stop of the chronograph mechanism and a reset button 908 for resetting the chronograph mechanism are disposed to the movement 800. A chronograph coupling lever 914 operated by the operation of the start/stop button 906 is provided in the chronograph unit 900.

(1.3) Second Chronograph Mechanism

Referring to FIG. 36-FIG. 38, a second chronograph intermediate wheel 920 is disposed so as to be rotatable with respect to the chronograph main plate 902 and the chronograph bridge 912. The second chronograph intermediate wheel 920 contains a second chronograph intermediate wheel axle 920b, a second chronograph intermediate gear wheel 920c, a second chronograph intermediate wheel clutch ring 920d, a second chronograph intermediate wheel clutch spring 920e, a second clutch cannon 920f, a second clutch spring seating 920g, and a second clutch ring 920h.

A second intermediate wheel 850 is provided rotatably with respect to the second chronograph intermediate wheel axle 920b. The second intermediate wheel 850 contains a second intermediate gear wheel 850b, and a second intermediate wheel clutch ring 850c. A second intermediate gear wheel clamp seating 850d is fixed to the second chronograph intermediate wheel axle 920b in order to rotatably hold the second intermediate wheel clutch ring 850c.

The second intermediate gear wheel 850b is rotated by a rotation of the 2nd second pinion 840d. A second wheel 852 is rotated by the rotation of the second intermediate gear wheel 850b. By a second hand (small second hand) 854 attached to the second wheel 852, there is displayed “second” at the present time.

If the chronograph coupling lever 914 is operated by the operation of the start/stop button 906, the second chronograph intermediate wheel clutch ring 920d is rotated while interlocking with the second intermediate wheel clutch ring 850c by a spring force of the second chronograph intermediate wheel clutch spring 920e. Under this state, the second chronograph intermediate gear wheel 920c is rotated by a rotation of the 2nd second pinion 840d. That is, the second chronograph intermediate wheel clutch ring 920d and the second intermediate wheel clutch ring 850c comprise a “clutch”. A second chronograph wheel 922 is rotated by a rotation of the second chronograph intermediate gear wheel 920c. The second chronograph wheel 922 contains a second chronograph gear wheel 922b, a second chronograph wheel axle 922c, a second heart 922d, and a stop lever plate 922f. At a chronograph measurement operation time, by a chronograph second hand 924 attached to the second chronograph wheel axle 922c, there is displayed a measurement result of an elapsed time of “second” such as one second has elapsed.

(1.4) Time Display Mechanism

Referring to FIG. 36, FIG. 37 and FIG. 39, a 2nd minute wheel 860 is disposed so as to be rotatable with respect to the chronograph main plate 902. The 2nd minute wheel 860 contains a 2nd minute gear wheel A 860a, a 2nd minute gear wheel B 860b, and a 2nd minute pinion 860c. The 2nd minute gear wheel A 860a meshes with the 2nd cannon pinion 832d. The 2nd minute wheel 860 is rotated by a rotation of the minute driving wheel & pinion 832. A 2nd minute driving wheel & pinion 862 is rotated by a rotation of the 2nd minute gear wheel B 860b. By a minute hand 864 attached to the 2nd minute driving wheel & pinion 862, there is displayed “minute” of the present time. A 2nd cannon wheel 866 is rotated by a rotation of the 2nd minute pinion 860c. By an hour hand 868 attached to the 2nd cannon wheel 866, there is displayed “hour” at the present time.

(1.5) Hour Chronograph Mechanism

An hour chronograph intermediate wheel 930 is disposed so as to be rotated by a rotation of the 2nd cannon wheel 866. An hour chronograph wheel 932 is disposed so as to be rotated by a rotation of the hour chronograph intermediate wheel 930. The hour chronograph wheel 932 contains an hour chronograph gear wheel 932b, an hour chronograph wheel axle 932c, an hour heart 932d, an hour chronograph wheel clutch spring 932e, an hour chronograph wheel clutch spring clamp seating 932f, an hour chronograph wheel clutch spring reception seating 932g, and an hour chronograph wheel clutch ring 932h. The hour chronograph gear wheel 932b is provided rotatably with respect to the hour chronograph wheel axle 932c.

If an hour chronograph coupling lever A 934 and an hour chronograph coupling lever B 936 are operated by the operation of the start/stop button 906, the hour chronograph wheel-axle 932c is rotated while interlocking with the hour chronograph gear wheel 932b by a spring force of the hour chronograph wheel clutch spring 932e. Under this state, the hour chronograph wheel axle 932c is rotated by a rotation of the hour chronograph intermediate wheel 930. That is, the hour chronograph wheel clutch ring 932h and the hour chronograph wheel clutch spring 932e comprise a “clutch”. At the chronograph measurement operation time, by a chronograph hour hand 938 attached to the hour chronograph wheel axle 932c, there is displayed a measurement result of an elapsed time of “hour” such as one hour has elapsed.

(1.6) Minute Chronograph Mechanism

Referring to FIG. 36, FIG. 37 and FIG. 40, a minute chronograph wheel 942 is disposed so as to be rotated by a rotation of the third transmission pinion 836d. The minute chronograph wheel 942 contains aminute chronograph gear wheel 942b, a minute chronograph wheel axle 942c, a minute heart 942d, a minute chronograph wheel clutch spring 942e, a minute chronograph wheel clutch spring clamp seating 942f, a minute chronograph wheel clutch spring reception seating 942g, and a minute chronograph clutch ring 942h. The minute chronograph gear wheel 942b is provided rotatably with respect to the minute chronograph wheel axle 942c.

If a minute chronograph coupling lever A 944 and a minute chronograph coupling lever B 946 are operated by the operation of the start/stop button 906, the minute chronograph wheel axle 942c is rotated while interlocking with the minute chronograph gear wheel 942b by a spring force of the minute chronograph wheel clutch spring 942e. Under this state, the minute chronograph wheel axle 932c is rotated by a rotation of the minute chronograph intermediate wheel 940. That is, the minute chronograph clutch ring 942h and the minute chronograph wheel clutch spring 942e comprise a “clutch”. At the chronograph measurement operation time, by a chronograph minute hand 948 attached to the minute chronograph wheel axle 942c, there is displayed a measurement result of an elapsed time of “minute” such as one minute has elapsed.

(1-7) Calendar Mechanism

Referring to FIG. 36, FIG. 37 and FIG. 41, an intermediate date wheel 870 is rotated by a rotation of the hour wheel 848. A date indicator driving wheel 872 is rotated by a rotation of the intermediate date wheel 870. A date finger 874 is rotated monolithically with the date indicator driving wheel 872. A date gear wheel 876 having thirty-one internal teeth is disposed rotatably with respect to the main plate 802. The date finger 874 can rotate the date gear wheel 876 by for one tooth per a day. A date gear wheel jumper 878 is provided in order to set a position of the date gear wheel 876 in a rotation direction. A date feed transmission wheel 880 is disposed so as to be rotatable with respect to the chronograph main plate 902 and the chronograph bridge 912. The date feed transmission wheel 880 contains a date feed transmission gear wheel A 880a, a date feed transmission gear wheel B 880b, and a date transmission feed wheel axle 880c. The date feed transmission gear wheel A 880a meshes with the date gear wheel 876.

A 2nd date indicator driving wheel 882 is provided so as to be rotated by a rotation of the date feed transmission wheel 880. The 2nd date indicator driving wheel 882 is disposed rotatably with respect to a 2nd date indicator driving wheel pin 882p fixed to the chronograph main plate 902. The 2nd date indicator driving wheel 882 contains a 2nd date indicator driving gear wheel 882b, and a 2nd date indicator driving cam 882c. The 2nd date indicator driving gear wheel 882b meshes with the date feed transmission gear wheel B 880b. A date indicator 886 having thirty-one internal teeth is disposed rotatably with respect to the chronograph bridge 912. A date jumper 888 is provided in order to set a position of the date indicator 886 in the rotation direction. The 2nd date indicator driving cam 882c can rotate the date indicator 886 by for one tooth per a day. By numerals “1”-“31”(not shown in the drawing) provided in the date indicator 886, “date” at the present can be displayed in a date window (not shown in the drawing) of the dial.

A part of the date jumper 888 is disposed so as to overlap with a part of the second wheel 852. A part of the minute chronograph wheel 942 is disposed so as to overlap with a part of the date indicator driving wheel 872. A part of the minute chronograph wheel 942 is disposed so as to overlap with a part of the intermediate date wheel 870. The date gear wheel jumper 878 is disposed so as to overlap with a part of the minute chronograph wheel 942. The date indicator 886 is disposed so as to overlap with the date gear wheel 876.

In this conventional 1st type chronograph time piece, it is comprised such that, when a base unit and a chronograph unit are connected in the movement, a power is transmitted from the three parts of the minute wheel, the third wheel & pinion and the second wheel & pinion, which are disposed in the base unit, to a chronograph train wheel disposed in the chronograph unit. That is, as to a twelve-hour timepiece of the chronograph, it is comprised such that the hour chronograph wheel is rotated on the basis of the rotation of the minute wheel (2nd cannon pinion). As to a thirty-minute timepiece of the chronograph, it is comprised such that the minute chronograph wheel is rotated on the basis of the rotation of the third wheel & pinion (third transmission pinion). As to a second display of the chronograph, it is comprised such that the second chronograph wheel is rotated on the basis of the rotation of the second wheel & pinion (2nd second pinion).

(2) Conventional 2nd Type Chronograph Timepiece

A conventional 2nd type chronograph timepiece has, in its chronograph measurement mode, a chronograph wheel provided rotatably on the basis of a rotation of a movement barrel complete, a minute chronograph train wheel provided so as to be rotated on the basis of a rotation of a chronograph wheel, and an hour chronograph train wheel provided so as to be rotated on the basis of a rotation of the chronograph wheel. Under a state that no chronograph mechanism is operating, a 1st chronograph coupling lever and a 2nd chronograph coupling lever contact with an outer periphery slant face portion of a second clutch ring 224, thereby separating the second clutch ring from a gear wheel upper face of a second wheel & pinion. A second clutch spring and the second clutch ring comprise a 1st clutch mechanism provided in the chronograph timepiece. An hour/minute chronograph intermediate wheel (A) is comprised so as to be rotated on the basis of a rotation of the chronograph wheel. An hour/minute chronograph intermediate wheel (B) is rotated on the basis of a rotation of the hour/minute chronograph intermediate wheel (A). The hour/minute chronograph intermediate wheel (B) penetrates through a part of a main plate. The hour/minute chronograph intermediate wheel (B) has a slip mechanism.

An hour chronograph transmission wheel (C) is rotated on the basis of a rotation of an hour/minute chronograph intermediate pinion (B). An hour chronograph transmission wheel (B) is rotated on the basis of a rotation of an hour chronograph transmission wheel (C). An hour chronograph transmission wheel (A) is rotated on the basis of a rotation of the hour chronograph transmission wheel (B). An hour chronograph wheel is rotated on the basis of a rotation of the hour chronograph transmission wheel (A). An hour clutch spring comprises a 2nd clutch mechanism. A minute chronograph intermediate wheel is rotated on the basis of a rotation of the hour/minute chronograph intermediate pinion (B). A minute chronograph wheel is rotated on the basis of a rotation of the minute chronograph intermediate wheel. A minute clutch spring comprises a 3rd clutch mechanism. A date indicator is rotatably incorporated into a 2nd train wheel bridge by a date indicator maintaining plate, thereby performing a display of “date”. The date indicator is operated by a calendar feed mechanism (for example, refer to JP-A-11-23741).

(3) Conventional 3rd Type Chronograph Timepiece

In a conventional 3rd type chronograph timepiece, as to a twelve-hour timepiece of the chronograph, it is comprises such that a wheel of an hour counter is rotated on the basis of a rotation of an hour wheel. As to a thirty-minute timepiece of the chronograph, it is comprises such that a wheel of a minute counter is rotated on the basis of a rotation of a 3rd wheel. As to a second display of the chronograph, it is comprised such that a chronograph wheel is rotated on the basis of a rotation of a gear wheel of a 1st removal device. (For example, refer to Japanese Patent No. 3336041.)

However, in the conventional chronograph timepieces, there have been such problems as shown below.

(1) Problem of the Conventional 1st Type Chronograph Timepiece

In the conventional 1st type chronograph timepiece, there has been a problem that it is impossible to rotate the third wheel & pinion by an external operation, and it is difficult to connect the base unit and the chronograph unit.

(2) Problem of the Conventional 2nd Type Chronograph Timepiece

In the conventional 2nd type chronograph timepiece, the clutch mechanism is provided in the front train wheel. Further, there has been a problem that the number of parts constituting the chronograph mechanism is large, so that the chronograph mechanism becomes complex.

(3) Problem of the Conventional 3rd Type Chronograph Timepiece

In the conventional 3rd type chronograph timepiece, there has been a problem that it is impossible to rotate the 3rd wheel by the external operation, and it is difficult to connect the base unit and the chronograph unit.

### SUMMARY OF THE INVENTION

An object of the invention is to realize a chronograph timepiece in which a manufacture and an assembly of the chronograph mechanism are easy.

Further, other object of the invention is to realize a chronograph timepiece comprised such that the train wheel can be operated from an outside and having a good after service ability.

In order to solve the above problems, the invention is comprised such that in a chronograph timepiece in which a mainspring provided in a movement barrel complete is made a power source, it possesses a base unit containing a main plate constituting a base plate of a movement, a front train wheel rotating on the basis of a rotation of a movement barrel complete and an escapement/speed control device for controlling a rotation of the front train wheel, and having at least one of a self-winding device or a hand winding device, and a chronograph unit containing a second display mechanism, a second chronograph train wheel, a minute chronograph train wheel and an hour chronograph train wheel, and the chronograph unit is disposed in a side where a dial exists than the base unit. The base unit contains a 1st transmission wheel and a 2nd transmission wheel, which are rotated on the basis of a rotation of the movement barrel complete, the second chronograph train wheel is comprised so as to be rotated on the basis of a rotation of the 1st transmission wheel, and the minute chronograph train wheel and the hour chronograph train wheel are comprised so as to be rotated on the basis of a rotation of the 2nd transmission wheel. The hour chronograph train wheel contains an hour chronograph wheel, the minute chronograph train wheel contains a minute chronograph wheel, and the second chronograph train wheel contains a second chronograph wheel. In a chronograph timepiece of the invention, “hour” of a chronograph measurement result is displayed by a chronograph hour hand attached to the hour chronograph wheel, “minute” of the chronograph measurement result is displayed by a chronograph minute hand attached to the minute chronograph wheel, and “second” of the chronograph measurement result is displayed by a chronograph second hand attached to the second chronograph wheel. By this constitution, it is possible to realize the chronograph timepiece in which the manufacture and the assembly of the chronograph mechanism are easy.

It is preferable that the 1st transmission wheel is a second wheel & pinion rotated on the basis of the rotation of the movement barrel complete, the second chronograph train wheel is comprised so as to be rotated on the basis of a rotation of the second wheel & pinion, the 2nd transmission wheel is a minute driving wheel rotated on the basis of the rotation of the movement barrel complete, and the minute chronograph train wheel and the hour chronograph train wheel are comprised so as to be rotated on the basis of a rotation of the minute. driving wheel. By this constitution, it is possible to realize the chronograph timepiece comprised such that the train wheel can be operated from the outside and having the good after service ability.

Further, in a chronograph timepiece of the invention, the minute driving wheel contains a cannon pinion, and additionally, in a chronograph timepiece of the invention, it is preferable that a 2nd minute wheel is comprised so as to be rotated on the basis of a rotation of the cannon pinion, and the minute chronograph wheel and the hour chronograph wheel are comprised so as to be rotated on the basis of a rotation of the 2nd minute wheel. By this constitution, it is possible to realize a chronograph timepiece whose number of parts is small and whose assembly is easy.

Further, it is preferable that a chronograph timepiece of the invention additionally possesses a date indicator for performing a calendar display, and the date indicator is comprised so as to be rotated on the basis of the rotation of the 2nd minute wheel. By this constitution, it is possible to realize a chronograph timepiece possessing the date indicator, whose number of parts is small and whose assembly is easy.

### BRIEF DESCRIPTION OF THE SEVERAL VIEWS OF THE DRAWINGS

A preferred form of the present invention is illustrated in the accompanying drawings in which:

FIG. 1 is a plan view showing a chronograph mechanism and a calendar mechanism under a state of being seen from a dial side in an embodiment of a chronograph timepiece of the invention.;

FIG. 2 is a partial plan view showing the chronograph mechanism in a start state under the state of being seen from the dial side in the embodiment of the chronograph timepiece of the invention;

FIG. 3 is a partial plan view showing the chronograph mechanism in a stop state under the state of being seen from the dial side in the embodiment of the chronograph timepiece of the invention;

FIG. 4 is a partial plan view showing the chronograph mechanism at a reset time under the state of being seen from the dial side in the embodiment of the chronograph timepiece of the invention;

FIG. 5 is a plan view showing a base unit under a state of being seen from a side opposite to the dial in the embodiment of the chronograph timepiece of the invention;

FIG. 6 is a plan view showing the base unit under the state of being seen from the dial side in the embodiment of the chronograph timepiece of the invention;

FIG. 7 is a plan view showing a chronograph unit under the state of being seen from the side opposite to the dial in the embodiment of the chronograph timepiece of the invention;

FIG. 8 is a plan view showing the chronograph unit under the state of being seen from the dial side in the embodiment of the chronograph timepiece of the invention;

FIG. 9 is a schematic block diagram showing transmission paths of a train wheel in the embodiment of the chronograph timepiece of the invention;

FIG. 10 is a partial sectional view showing transmission paths of a date feed train wheel in the embodiment of the chronograph timepiece of the invention;

FIG. 11 is a partial sectional view showing transmission paths of an hour chronograph train wheel in the embodiment of the chronograph timepiece of the invention;

FIG. 12 is a partial sectional view showing transmission paths of a minute chronograph train wheel in the embodiment of the chronograph timepiece of the invention;

FIG. 13 is a partial sectional view showing transmission paths of a second chronograph train wheel in the embodiment of the chronograph timepiece of the invention;

FIG. 14 is a partial sectional view showing transmission paths of a calendar corrector train wheel in the embodiment of the chronograph timepiece of the invention;

FIG. 15 is a schematic plan view showing an external appearance of a complete of the chronograph timepiece under a state that the chronograph mechanism is stopped in the embodiment of the chronograph timepiece of the invention;

FIG. 16 is a partial plan view showing an operating lever and an operation cam under a state that the chronograph mechanism is not driven in the embodiment of the chronograph timepiece of the invention;

FIG. 17 is a partial plan view showing a chronograph coupling lever and the operation cam under a state that a clutch is made OFF in the embodiment of the chronograph timepiece of the invention;

FIG. 18 is a partial sectional view showing the chronograph coupling lever and the operation cam under the state that the clutch is made OFF in the embodiment of the chronograph timepiece of the invention;

FIG. 19 is a partial plan view showing an hour/minute chronograph coupling lever and the operation cam under the state that the clutch is made OFF in the embodiment of the chronograph timepiece of the invention;

FIG. 20 is a partial sectional view showing the hour/minute chronograph coupling lever and the operation cam under the state that the clutch is made OFF in the embodiment of the chronograph timepiece of the invention;

FIG. 21 is a partial plan view showing the operating lever and the operation cam under a state that the chronograph mechanism is driven in the embodiment of the chronograph timepiece of the invention;

FIG. 22 is a partial plan view showing the chronograph coupling lever and the operation cam under a state that the clutch is made ON in the embodiment of the chronograph timepiece of the invention;

FIG. 23 is a partial sectional view showing the chronograph coupling lever and the operation cam under the state that the clutch is made ON in the embodiment of the chronograph timepiece of the invention;

FIG. 24 is a partial plan view showing the hour/minute chronograph coupling lever and the operation cam under the state that the clutch is made ON in the embodiment of the chronograph timepiece of the invention;

FIG. 25 is a partial sectional view showing the hour/minute chronograph coupling lever and the operation cam under the state that the clutch is made ON in the embodiment of the chronograph timepiece of the invention;

FIG. 26 is a functional block diagram showing a constitution of a chronograph coupling mechanism in the embodiment of the chronograph timepiece of the invention;

FIG. 27 is a partial plan view showing a stop lever and the operation cam in a run state under a state that a setting is made OFF in the embodiment of the chronograph timepiece of the invention;

FIG. 28 is a partial sectional view showing the stop lever and the operation cam in the run state under the state that the setting is made OFF in the embodiment of the chronograph timepiece of the invention;

FIG. 29 is a partial plan view showing the stop lever and the operation cam in a stop state under a state that the setting is made ON in the embodiment of the chronograph timepiece of the invention;

FIG. 30 is a partial sectional view showing the stop lever and the operation cam in the stop state under the state that the setting is made ON in the embodiment of the chronograph timepiece of the invention;

FIG. 31 is a partial plan view showing the stop lever and the operation cam in a reset state in the embodiment of the chronograph timepiece of the invention;

FIG. 32 is a partial sectional view showing the stop lever and the operation cam in the reset state in the embodiment of the chronograph timepiece of the invention;

FIG. 33 is a partial plan view showing a hammer and the operation cam in the stop state in the embodiment of the chronograph timepiece of the invention;

FIG. 34 is a partial plan view showing the hammer and the operation cam in the reset state in the embodiment of the chronograph timepiece of the invention;

FIG. 35 is a functional block diagram showing a constitution of a reset mechanism in the embodiment of the chronograph timepiece of the invention;

FIG. 36 is a plan view showing a chronograph mechanism and a calendar mechanism under a state of being seen from a dial side in a conventional chronograph timepiece;

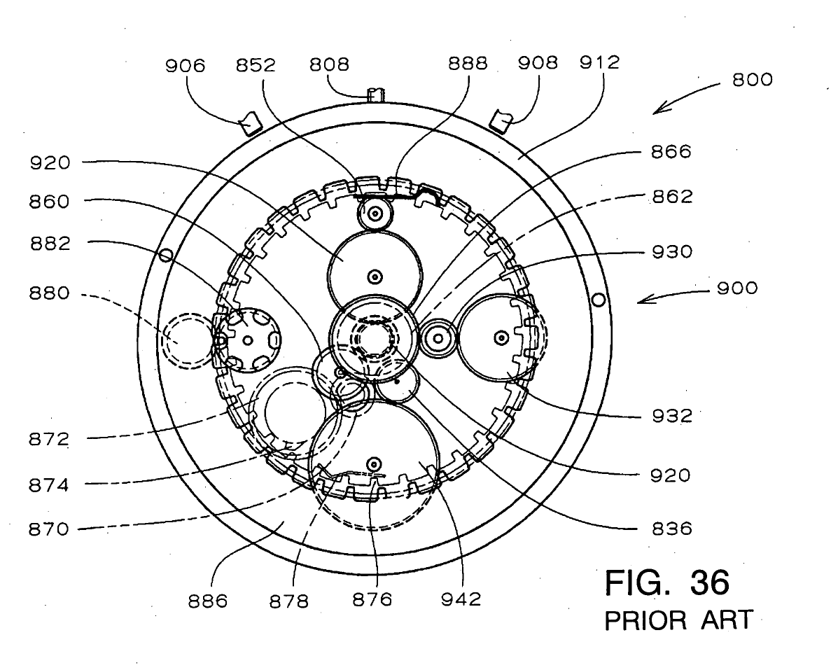

FIG. 37 is a schematic block diagram showing transmission paths of a train wheel in the conventional chronograph timepiece;

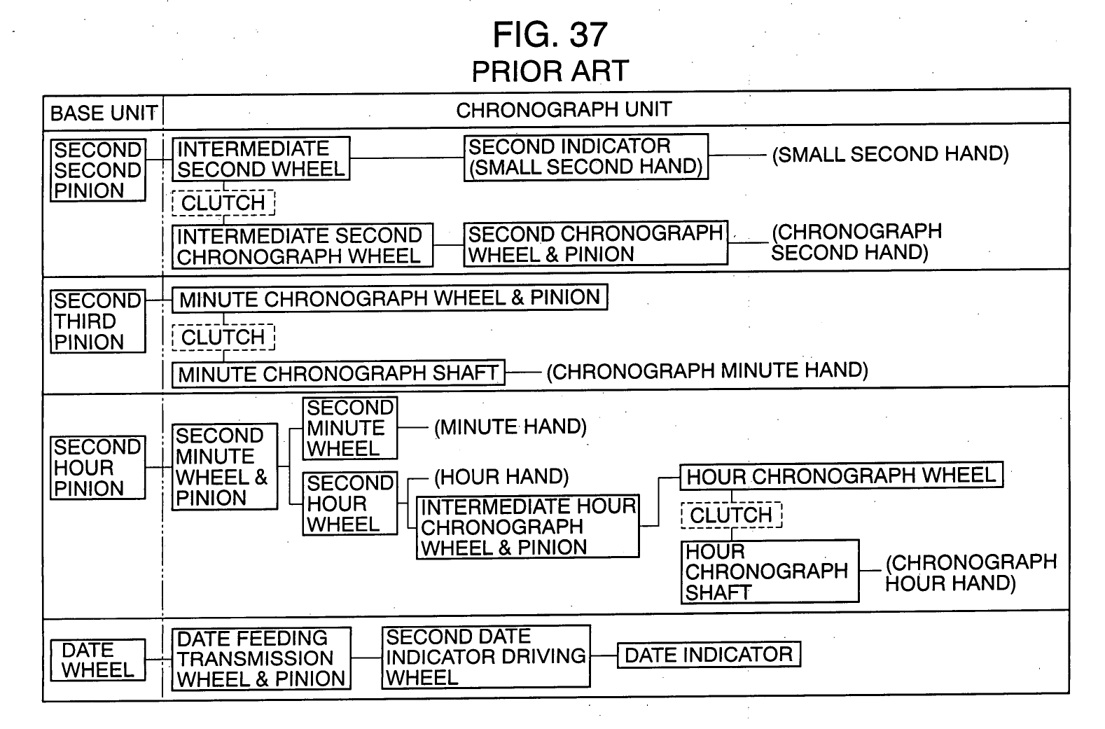

FIG. 38 is a partial sectional view showing transmission paths of a second chronograph train wheel in the conventional chronograph timepiece;

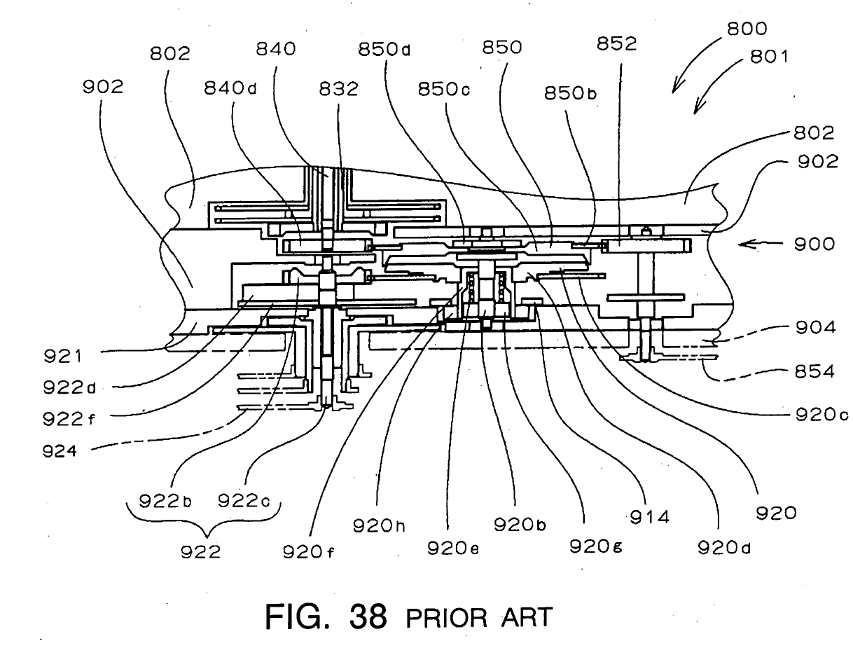

FIG. 39 is a partial sectional view showing transmission paths of an hour chronograph train wheel in the conventional chronograph timepiece;

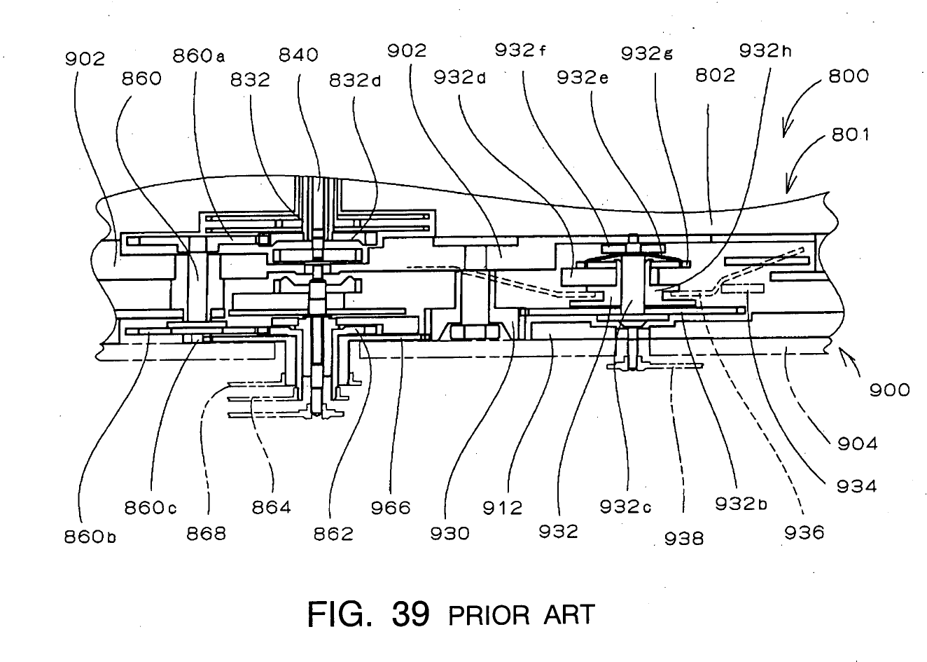

FIG. 40 is a partial sectional view showing transmission paths of a minute chronograph train wheel in the conventional chronograph timepiece; and

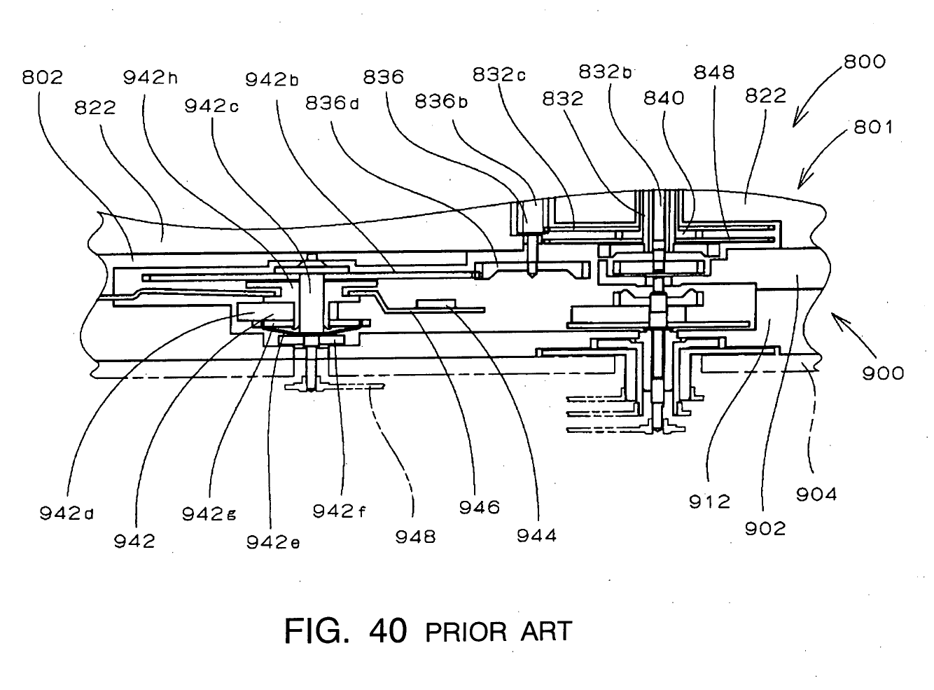

FIG. 41 is a partial sectional view showing transmission paths of a calendar feed train wheel in the conventional chronograph timepiece.

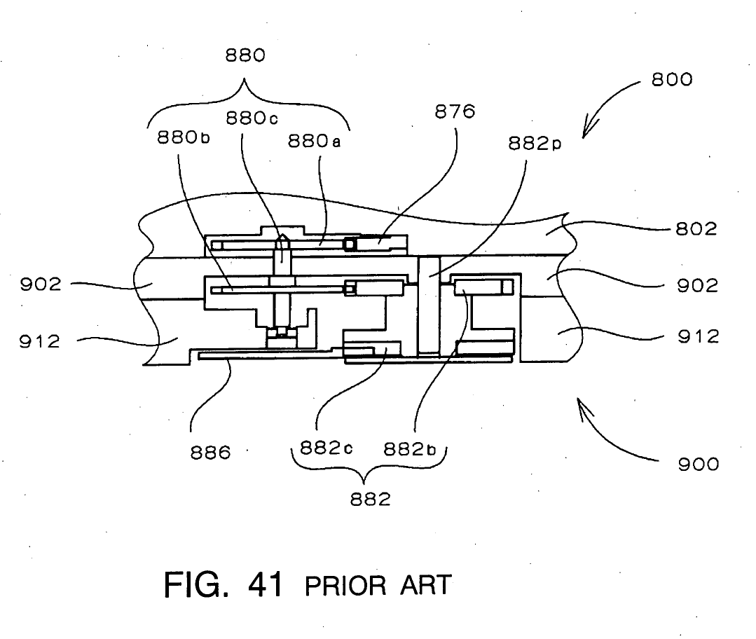

### DETAILED DESCRIPTION OF THE PREFERRED EMBODIMENTS

Hereunder, an embodiment of the invention is explained on the basis of the drawings.

Incidentally, in order to make the explanations clear, in each of the drawings, there is omitted a depiction of a structure of a portion whose relation with a constitution of the invention is thin. Accordingly, there are omitted detailed explanations concerning structures of a rocking device, a hand setting device, a self-winding device, a hand winding device, a calendar device, a calendar corrector device, and the like, in each of which a structure similar to the conventional chronograph timepiece can be utilized.

(1) Whole Constitution of Movement and Definition of Term

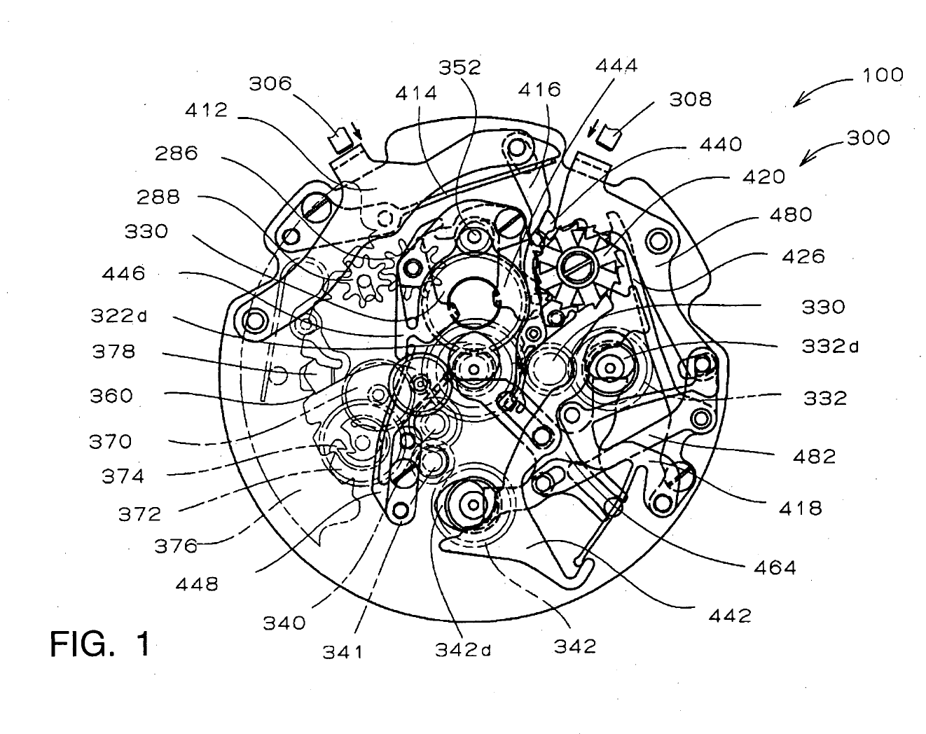

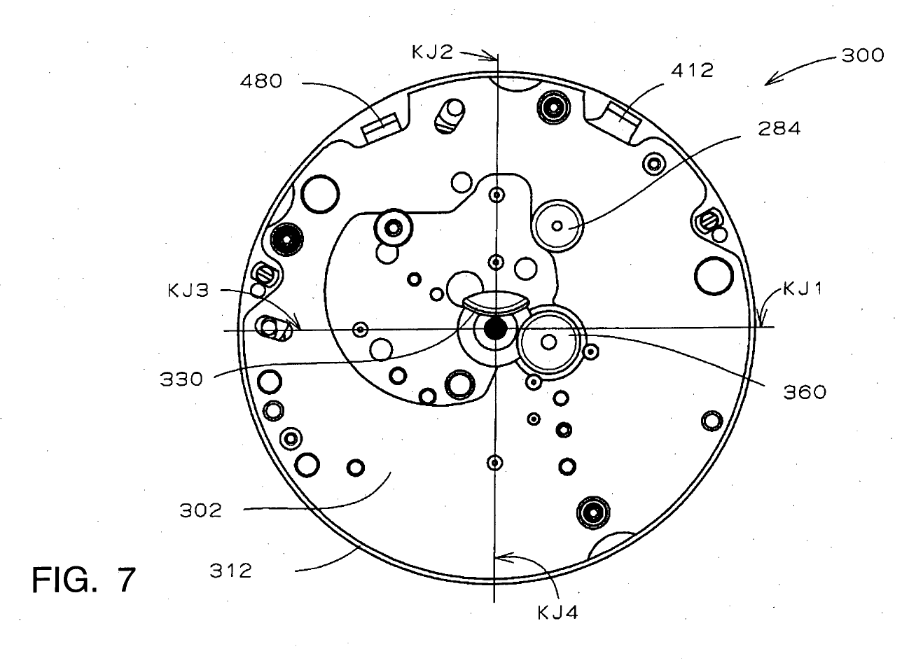

Referring to FIG. 1-FIG. 8, a movement (machine body containing a drive section) 100 of a chronograph timepiece of the invention possesses a base unit 101 containing a front train wheel, a rear train wheel, a rocking device, a hand setting device, a self-winding device, a hand winding device and the like, and a chronograph unit 300 containing a chronograph mechanism, a calendar mechanism (calendar feed mechanism, and calendar corrector mechanism), a train wheel for indicating hand drive and the like. The base unit 101 is comprised so as to possess at least one of the self-winding device and the hand winding device.

Among both sides of a main plate 102, a side in which a dial 104 exists is referred to as “rear side” of the movement 100, and a side opposite to the side in which the dial 104 exists is referred to as “front side” of the movement 100. A train wheel incorporated into the “front side” of the movement 100 is referred to as “front train wheel”, and a train wheel incorporated into the “rear side” of the movement 100 is referred to as “rear train wheel”. In an outer periphery portion in a surface of the dial 104, there are usually provided numerals from 1 to 12; or abbreviated characters etc. corresponding to the numerals. Accordingly, each direction along the outer periphery portion of the timepiece can be expressed by using the numeral.

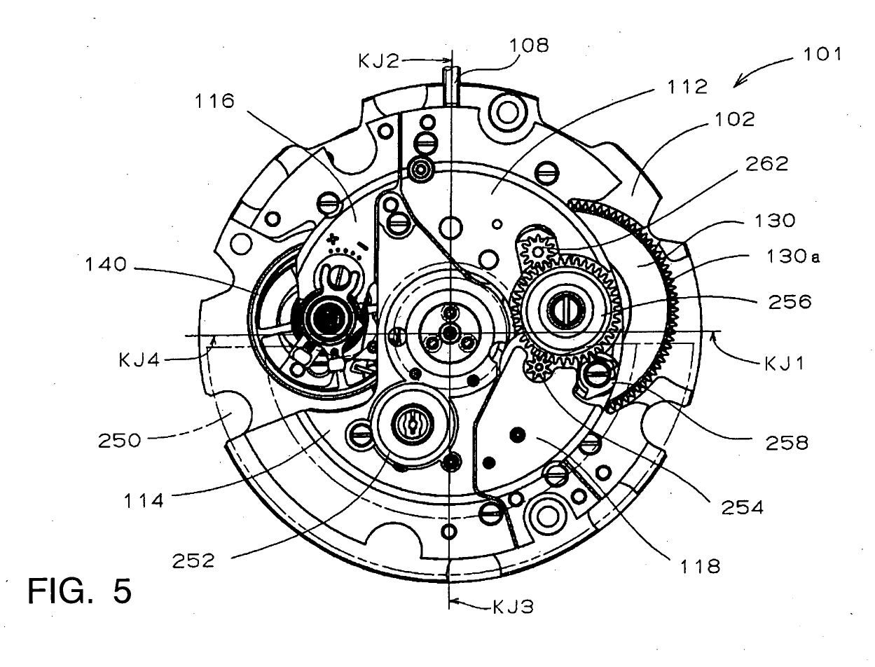

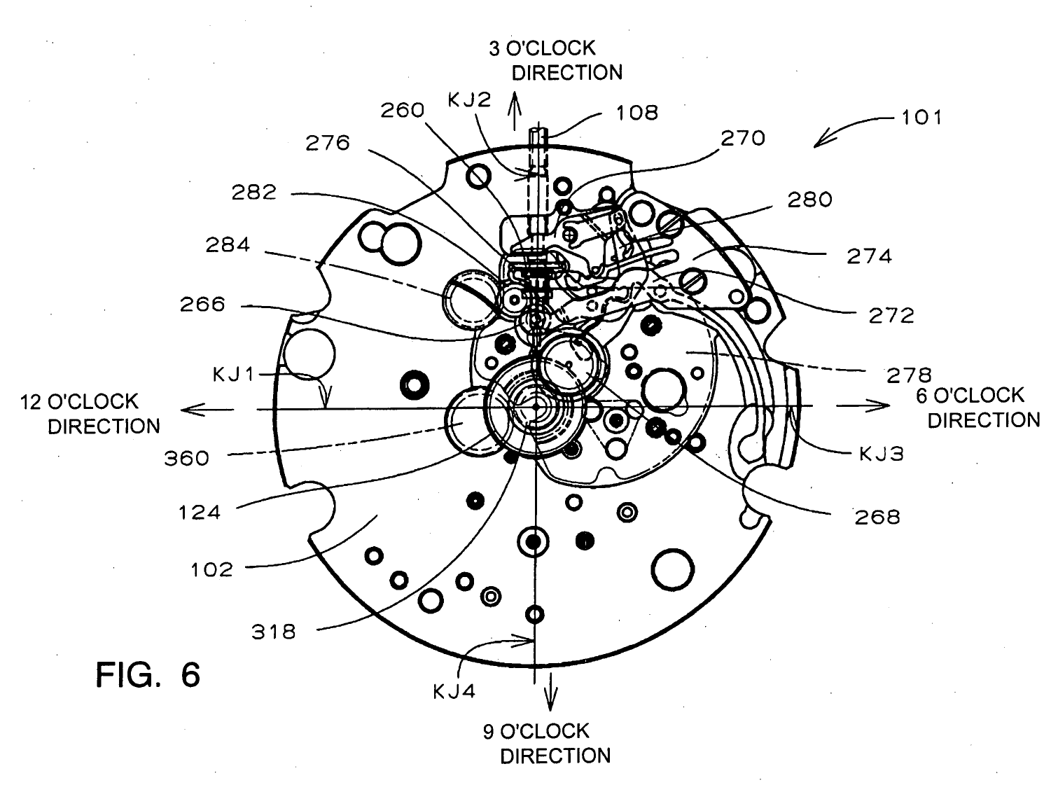

The movement 100 possesses the base unit 101 (refer to FIG. 5 and FIG. 6) containing the front train wheel, the rear train wheel, the rocking device, the hand setting device, the self-winding device and/or the hand winding device and the like, and the chronograph unit 300 (refer to FIG. 1-FIG. 4) containing the chronograph mechanism, the calendar mechanism and the like. The base unit 101 contains the main plate 102, and one or more bridge(s). The chronograph unit 300 contains a chronograph main plate 302, and a chronograph bridge 312.

For example, in the case of a wristwatch, an upper direction and an upper side of the wristwatch are respectively referred to as “12 O'clock direction” and “12 o'clock side”, a right direction and a right side of the wristwatch are respectively referred to as “3 O'clock direction” and “3 o'clock side”, a lower direction and a lower side of the wristwatch are respectively referred to as “6 o'clock direction” and “6 o'clock side”, and a left direction and a left side of the wristwatch are respectively referred to as “9 o'clock direction” and “9 o'clock side”. Similarly, an upper direction and an upper side of the movement 100 are respectively referred to as “12 o'clock direction” and “12 o'clock side”, a right direction and a right side of the movement 100 are respectively referred to as “3 o'clock direction” and “3 o'clock side”, a lower direction and a lower side of the movement 100 are respectively referred to as “6 o'clock direction” and “6 o'clock side”, and a left direction and a left side of the movement 100 are respectively referred to as “9 o'clock direction” and “9 o'clock side”.

In the movement 100, a position corresponding to a 12 o'clock graduation of the dial 104 is referred to as “12 o'clock position”, a position corresponding to a 1 o'clock graduation of the dial 104 is referred to as “1 o'clock position”, a position corresponding to a 3 o'clock graduation of the dial 104 is referred to as “3 o'clock position”, similarly “4 o'clock position” to “10 o'clock position” are defined, and finally a position corresponding to an 11 o'clock graduation of the dial 104 is referred to as “11 o'clock position”.

In the movement 100, a direction from a center 402 of the movement 100 toward the “12 o'clock position” is referred to as “12 o'clock direction”, a direction from the center 402 of the movement 100 toward the “1 o'clock position” is referred to as “1 o'clock direction”, a direction from the center 402 of the movement 100 toward the “2 o'clock position” is referred to as “2 o'clock direction”, a direction from the center 402 of the movement 100 toward the “3 o'clock position” is referred to as “3 o'clock direction”, similarly “4 o'clock direction” to “10 o'clock direction” are defined, and finally a direction from the center 402 of the movement 100 toward the “11 o'clock position” is referred to as “11 o'clock direction”.

For example, in FIG. 6, there are shown the “12 o'clock direction”, the“3 o'clock direction”, the “6 o'clock direction”, and the “9 o'clock direction” of the movement 100.

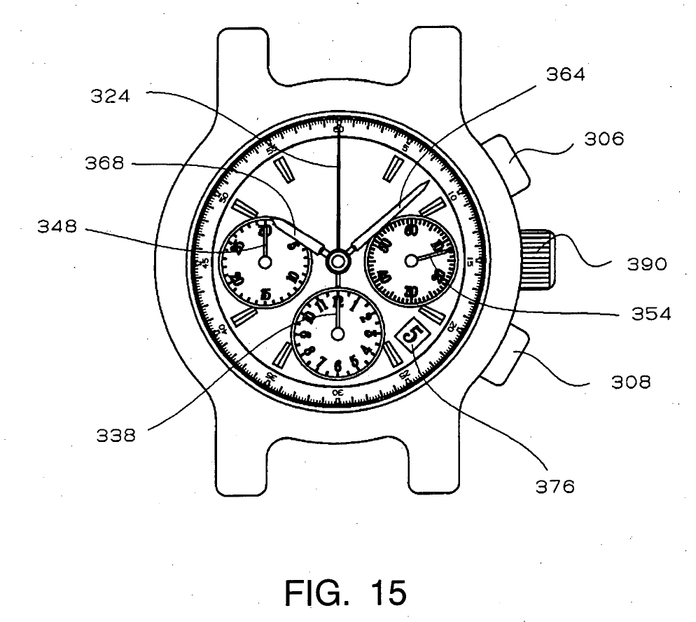

Referring to FIG. 5-FIG. 8, in the movement 100 (the base unit 101, and the chronograph unit 300), in the center 402 of the movement 100, there are positioned a rotation center of an hour hand 368, a rotation center of a minute hand 364, and a rotation center of a chronograph second hand 324 (refer to FIG. 15). In the movement 100 (the base unit 101, and the chronograph unit 300), a sector region, which is positioned between a 12 o'clock direction base line KJ1 toward the “12 o'clock direction” from the center 402 of the movement 100 (the base unit 101, and the chronograph unit 300) and a 3 o'clock direction base line KJ2 toward the “3 o'clock direction” from the center 402 of the movement 100 (the base unit 101, and the chronograph unit 300) and whose opening angle is 90 degrees, is referred to as “12 o'clock-3 o'clock region”, a sector region, which is positioned between the 3 o'clock direction base line KJ2 and a 6 o'clock direction base line KJ3 toward the “6 o'clock direction” from the center 402 of the movement 100 (the base unit 101, and the chronograph unit 300) and whose opening angle is 90 degrees, is referred to as “3 o'clock-6 o'clock region”, a sector region, which is positioned between the 6 o'clock direction base line KJ3 and a 9 o'clock direction base line KJ4 toward the “9 o'clock direction” from the center 402 of the movement 100 (the base unit 101, and the chronograph unit 300) and whose opening angle is 90 degrees, is referred to as “6 o'clock-9 o'clock region”, and a sector region, which is positioned between the 9 o'clock direction base line KJ4 and the 12 o'clock direction base line KJ1 and whose opening angle is 90 degrees, is referred to as “9 o'clock-12 o'clock region”. Accordingly, in the movement 100 (the base unit 101, and the chronograph unit 300), there are defined the four regions of the “12 o'clock-3 o'clock region”, the “3 o'clock-6 o'clock region”, the “6 o'clock-9 o'clock region” and the “9 o'clock-12 o'clock region”. A center axis of a winding stem 108 is disposed on the 3 o'clock direction base line KJ2 of the movement 100 (base unit 101).

(2) Constitution of Base Unit

Referring to FIG. 5 and FIG. 6, the base unit 101 has the main plate 102 constituting a base plate of the movement 100, the front train wheel, the rear train wheel, a barrel bridge 112, a train wheel bridge 114, a balance bridge 116, a self-winding train wheel bridge 118, an escapement/speed control device, the self-winding device, the hand winding device, a rocking device, a minute train cover 278, and the like.

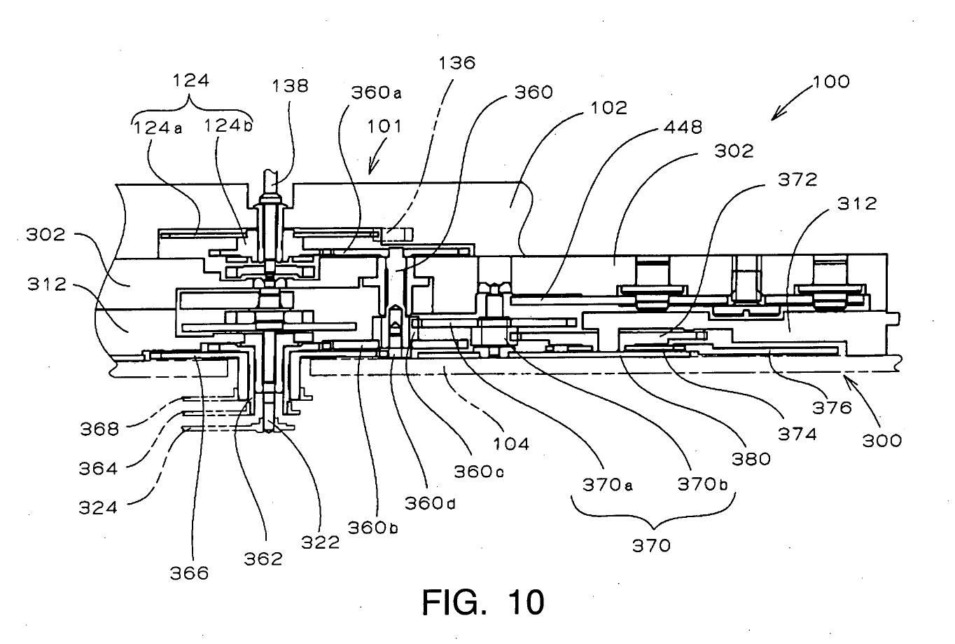

The winding stem 108 is rotatably incorporated into a winding stem guide hole of the main plate 102. The dial 104 (shown by virtual lines in FIG. 10-FIG. 14) is attached to the movement 100. The escapement/speed control device containing a balance with hairspring 140, an escape wheel & pinion (not shown in the drawing) andapallet fork (not shown in the drawing), and a front train wheel containing a second wheel & pinion 138 (refer to FIG. 10), a third wheel & pinion 136 (refer to FIG. 10), a center wheel & pinion (not shown in the drawing) and a movement barrel complete 130 are disposed in the “front side” of the base unit 101. Additionally, in the “front side” of the base unit 101 there are disposed the barrel bridge 112 supporting an upper axle part of the movement barrel complete 130 and an upper axle part of the center wheel & pinion so as to be rotatable, the train wheel bridge 114 supporting an upper axle part of the third wheel & pinion 136, an upper axle part of the second wheel & pinion 138 and an upper axle part of the escape wheel & pinion so as to be rotatable, a pallet fork bridge (not shown in the drawing) supporting an upper axle part of the pallet fork so as to be rotatable, and a balance bridge 116 supporting an upper axle part of the balance with hairspring 140 so as to be rotatable.

An axial direction position of the winding stem 108 is determined by the rocking device containing a setting lever, a yoke, a yoke spring, a yoke holder, and the like. If the winding stem 108 is rotated under a state that the winding stem 108 exists in a 1st winding stem position (0th step) nearest to an inside of the movement 100 along a rotation axis direction, a winding pinion 260 is rotated through a rotation of a clutch wheel 276. A crown wheel (not shown in the drawing) is comprised so as to be rotated by a rotation of the winding pinion. A crown transmission wheel (not shown in the drawing) is comprised so as to be rotated by a rotation of the crown wheel. A ratchet sliding wheel 262 is comprised so as to be rotated by a rotation of the crown transmission wheel. A ratchet wheel 256 is rotated by a rotation of the ratchet sliding wheel 262. The movement barrel complete 130 possesses a barrel drum gear wheel 130a, a barrel arbor (not shown in the drawing), and a mainspring (not shown in the drawing). It is comprised such that the mainspring accommodated in the movement barrel complete 130 is wound up by the fact that the ratchet wheel 256 rotates.

The center wheel & pinion is comprised so as to be rotated by a rotation of the movement barrel complete 130. The center wheel & pinion contains a center gear wheel (not shown in the drawing), and a center pinion (not shown in the drawing). The barrel drum gear wheel 130a is comprised so as to mesh with the center pinion. The third wheel & pinion 136 is comprised so as to be rotated by a rotation of the center wheel & pinion. The third wheel & pinion 136 contains a third gear wheel (not shown in the drawing), and a third pinion (not shown in the drawing). The second wheel & pinion 138 is comprised so as to be rotated by a rotation of the third wheel & pinion 136. The second wheel & pinion 136 contains a second gear wheel (not shown in the drawing), and a second pinion (not shown in the drawing). The third wheel & pinion is comprised so as to mesh with the second pinion. An escape wheel & pinion is comprised so as to be rotated by a rotation of the second wheel & pinion 138 while being controlled by a pallet fork. The escape wheel & pinion contains an escape gear wheel (not shown in the drawing), and an escape pinion (not shown in the drawing). The second gear wheel is comprised so as to mesh with the escape pinion. The movement barrel complete 130, the center wheel & pinion, the third wheel & pinion 136, and the second wheel & pinion 138 comprise the front train wheel.

The escapement/speed control device for controlling a rotation of the front train wheel contains the balance with hairspring 140, the escape wheel & pinion, and the pallet fork. The balance with hairspring 140 contains a balance staff, a balance wheel, and a hairspring. The hairspring is a thin plate spring in a vortex-like (spiral) form having plural turn numbers. The balance with hairspring 140 is supported so as to be rotatable with respect to the main plate 102 and the balance bridge 116.

Referring to FIG. 6 and FIG. 10, a minute driving wheel & pinion 124 contains a minute driving wheel 124a and a cannon pinion 124b. The minute driving wheel 124a is comprised so as to mesh with the third pinion of the third wheel & pinion 136. The minute driving wheel 124a and the cannon pinion 124b are comprised so as to be monolithically rotated. The cannon pinion 124b and the minute driving wheel 124a are provided with a slip mechanism comprised such that the cannon pinion 124b can slip with respect to the minute driving wheel 124a. The minute train cover 278 supports the minute driving wheel & pinion 124 with respect to the main plate 102 so as to be rotatable.

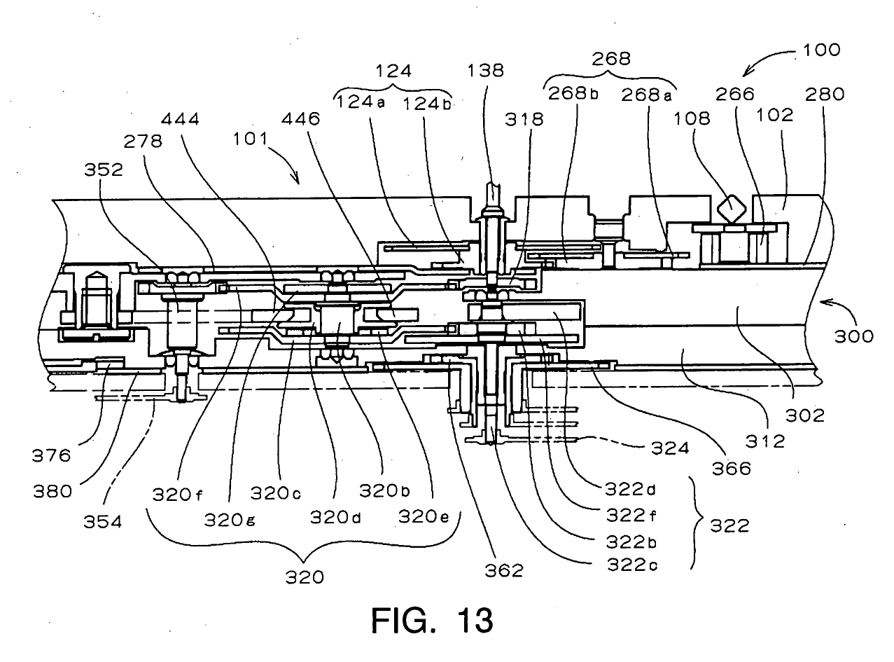

Referring to FIG. 6 and FIG. 13, a minute wheel 268 contains a minute gear wheel 268a, and a minute pinion 268b. The cannon pinion 124b is comprised so as to mesh with the minute pinion 268b. If the winding stem 108 is drawn out along its rotation axis direction to a state existing in a 3rd winding stem position (2nd step), a setting lever 280 is rotated. Under this state, if the winding stem 108 is rotated, a setting wheel 266 is rotated through a rotation of the clutch wheel 276. It is comprised such that, by a rotation of the setting wheel 266, the cannon pinion 124b is rotated through a rotation of the minute wheel 268. Accordingly, it is comprised such that a hand setting can be performed by drawing out the winding stem 108 to the 2nd step and rotating the winding stem 108.

Referring to FIG. 5 and FIG. 6, the self-winding device possesses an oscillating weight 250, a first intermediation wheel 252 rotated on the basis of a rotation of the oscillating weight 250, a second intermediation wheel (not shown in the drawing) rotated on the basis of a rotation of the first intermediation wheel 252, a rocking transmission wheel (not shown in the drawing) rotated in one direction on the basis of rotations of the first intermediation wheel 252 and the second intermediation wheel, a first transmission wheel (not shown in the drawing) rotated on the basis of a rotation of the rocking transmission wheel, a second transmission wheel (not shown in the drawing) rotated on the basis of a rotation of the first transmission wheel, and a third transmission wheel 254 rotated on the basis of a rotation of the second transmission wheel. A third transmission pinion of the third transmission wheel 254 is comprised so as to mesh with the ratchet wheel 256.

The hand winding device contains the winding pinion 260 rotated by a rotation of the winding stem 108, a crown wheel (not shown in the drawing) rotated by a rotation of the winding pinion 260, acrown transmission wheel (not shown in the drawing) rotated by a rotation of the crown wheel, the ratchet sliding wheel 262 rotated bya rotation of the crown transmission wheel, the ratchet wheel 256 in one direction on the basis of a rotation of the ratchet sliding wheel 262, and a click 258 for preventing a reverse rotation of the ratchet wheel 256. The axial direction position of the winding stem 108 is determined by the rocking device containing a setting lever 270, a yoke 272, a yoke holder 274, and the like. If the winding stem 108 is rotated under the state that the winding stem 108 exists in the 1st winding stem position (0th step) nearest to the inside of the movement 100 along the rotation axis direction, the winding pinion 260 is rotated through the rotation of the clutch wheel 276. The crown transmission wheel is rotated by a rotation of the winding pinion 260 through a rotation of the crown wheel. The ratchet sliding wheel 262 is rotated by a rotation of the crown transmission wheel. The ratchet wheel 256 is rotated in one direction on the basis of a rotation of the ratchet sliding wheel 262, and can wind up the mainspring.

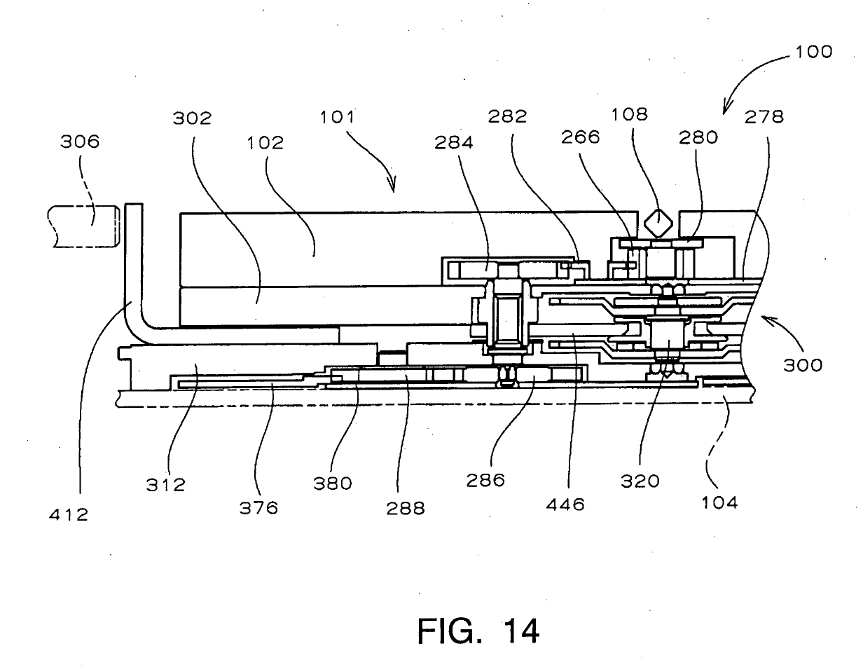

Referring to FIG. 6 and FIG. 14, the rear train wheel contains the setting wheel 266, and the minute wheel 268. A calendar corrector device contains the setting lever 280, a date corrector setting transmission wheel A 282, a date corrector setting transmission wheel B 284, a date corrector setting transmission wheel C 286, a date corrector setting wheel A 288, and the like. A rotation center of the minute wheel 268 is disposed in the “3 o'clock-6 o'clock region”.

(3) Constitution of Hour/Minute Display Mechanism

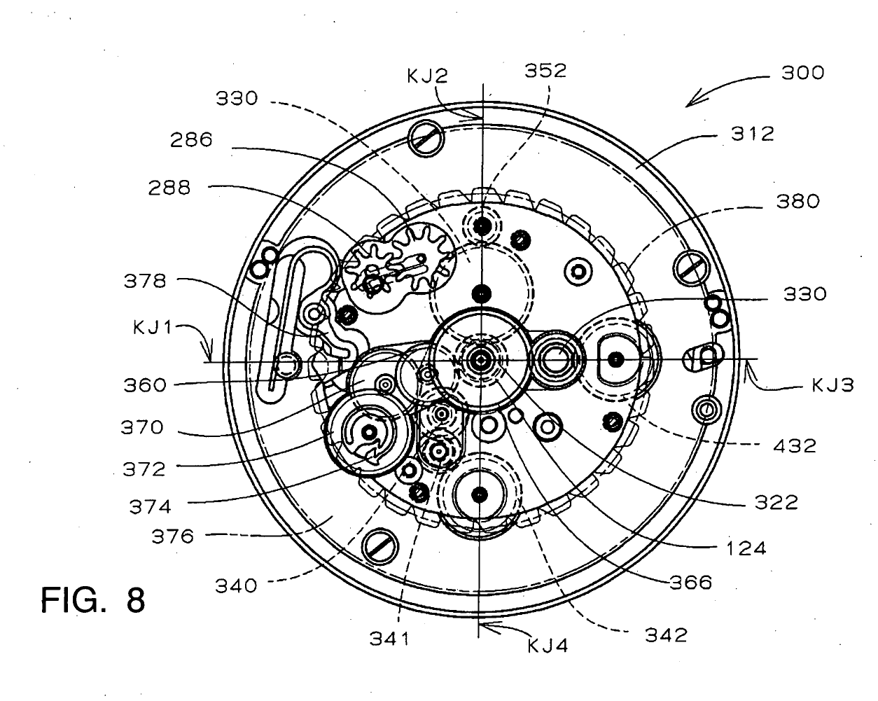

Referring to FIG. 8-FIG. 10, a 2nd minute wheel 360 is disposed so as to be rotatable with respect to the chronograph main plate 302. The 2nd minute wheel 360 contains a 2nd minute gear wheel A 360a, a 2nd minute gear wheel B 360b, a 2nd minute pinion A 360c, and a 2nd minute pinion B 360d. The 2nd minute gear wheel A 360a meshes with the cannon pinion 124b. A rotation center of the 2nd minute wheel 360 is disposed in the “9 o'clock-12 o'clock region”. The 2nd minute wheel 360 is rotated by a rotation of the minute driving wheel & pinion 124. A 2nd minute driving wheel & pinion 362 is rotated by a rotation of the 2nd minute gear wheel B 360b. The 2nd minute driving wheel & pinion 362 is disposed so as to be movable with respect to a 2nd minute wheel pipe fixed to the chronograph bridge 312. By a minute hand 364 attached to the 2nd minute driving wheel & pinion 362, “minute” at the present time is displayed. An hour wheel 366 is rotated by a rotation of the 2nd minute pinion B 360d. By an hour hand 368 attached to the hour wheel 366, “hour” at the present time is displayed.

If the winding stem 108 is drawn out to the 2nd step and the winding stem 108 is rotated, the setting wheel 266 is rotated through a rotation of the clutch wheel 276. The cannon pinion 124b is rotated by a rotation of the setting wheel 266 through a rotation of the minute wheel 268. The 2nd minute wheel 360 is rotated by a rotation of the cannon pinion 124b. The 2nd minute driving wheel & pinion 362 and the hour wheel 366 are rotated by a rotation of the 2nd minute wheel 360. Accordingly, the hand setting can be performed by drawing out the winding stem 108 to the 2nd step and rotating the winding stem 108.

(4) Constitution of Calendar Mechanism

Referring to FIG. 8-FIG. 10, an intermediate date wheel 370 is rotated by a rotation of the 2nd minute wheel 360. The intermediate date wheel 370 contains an intermediate date gear wheel 370a, and an intermediate date pinion 370b. The intermediate date gear wheel 370a meshes with the 2nd minute pinion A 360c. A date indicator driving wheel 372 is rotated by a rotation of the intermediate date wheel 370. A date finger 374 is rotated monolithically with the date indicator driving wheel 372. A rotation center of the date indicator driving wheel 372 and a rotation center of the intermediate date wheel 370 are disposed in the “9 o'clock-12 o'clock region”. That is, a date feed mechanism is disposed in the “9 o'clock-12 o'clock region”. The date indicator driving wheel 372 is disposed so as not to overlap with the train wheel constituting the chronograph mechanism. The intermediate date wheel 370 is disposed so as not to overlap with the train wheel constituting the chronograph mechanism.

A date indicator 376 having thirty-one internal teeth is disposed rotatably with respect to the chronograph bridge 312. The date finger 374 can rotate the date indicator 376 by for one tooth per a day. A date jumper 378 is provided in order to set a rotation direction position of the date indicator 376. A rotation center of the date jumper 378 is disposed in the “12 o'clock-3 o'clock region”. The date jumper 378 is disposed so as not to overlap with the train wheel constituting the chronograph mechanism. It is preferable that the date jumper 378 is disposed so as to overlap with the 12 o'clock direction base line KJ1 of the movement 100 (chronograph unit 300)

A position where the date jumper 378 sets the date indicator 376 is disposed in the “12 o'clock direction”. That is, it is preferable to comprise such that the 12 o'clock direction base line KJ1 of the movement 100 (chronograph unit 300) is positioned between two teeth of the date indicator 376 set by the date jumper 378. By this constitution, it is possible to realize a thin type chronograph timepiece having a thin type chronograph mechanism in which the two teeth of the date indicator 376 can be surely set.

A date indicator maintaining plate 380 is disposed with respect to the chronograph bridge 312 in order to support a teeth portion of the date indicator so as to be rotatable. By numerals “1”-“31” (not shown in the drawing) provided in the date indicator 376, “date” at the present can be displayed in a date window (not shown in the drawing) of the dial 104.

(5) Constitution of Hour Chronograph Train Wheel

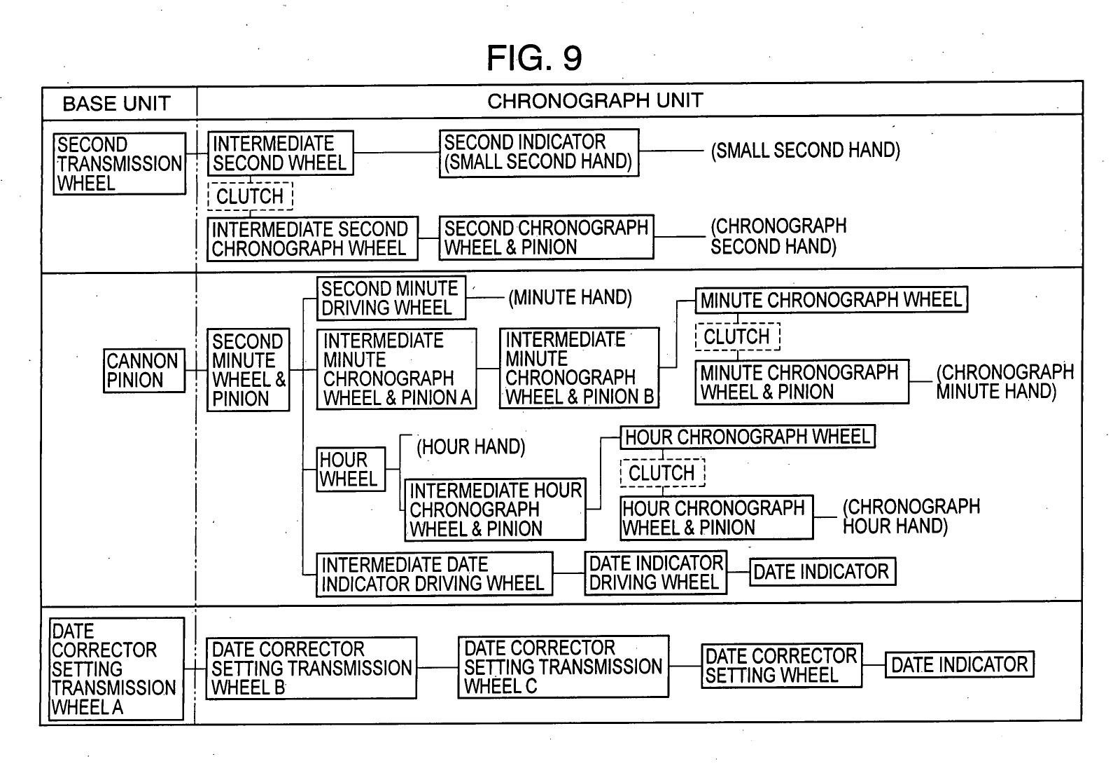

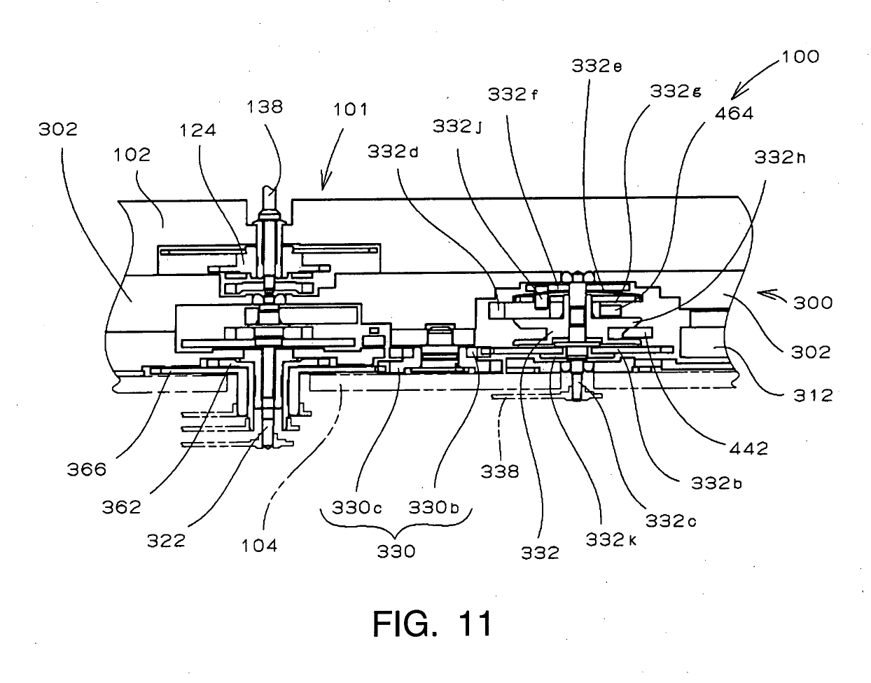

Referring to FIG. 1-FIG. 4, FIG. 8, FIG. 9 and FIG. 11, an hour chronograph intermediate wheel 330 is disposed so as to be rotatable with respect to the chronograph bridge 312. It is preferable that a rotation center of the hour chronograph intermediate wheel 330 is disposed so as to exist on the 6 o'clock direction base line KJ3 of the movement 100. A rotation center of the hour chronograph intermediate wheel 330 may be disposed so as to exist in the “3 o'clock-6 o'clock region” of the movement 100, or may be disposed so as to exist in the “6 o'clock-9 o'clock region” of the movement 100. It is especially preferable that the hour chronograph intermediate wheel 330 is disposed so as to overlap with the 6 o'clock direction base line KJ3 of the movement 100. By this constitution, it is possible to realize a small and thin type chronograph timepiece.

The hour chronograph intermediate wheel 330 is disposed so as to be rotated by a rotation of the hour wheel 366. The hour chronograph intermediate wheel 330 contains an hour chronograph intermediate gear wheel 330b, and an hour chronograph intermediate pinion 330c. The hour chronograph intermediate gear wheel 330b meshes with the hour wheel 366. An hour chronograph wheel 332 is disposed so as to be rotatable with respect to the chronograph main plate 302 and the chronograph bridge 312. The hour chronograph wheel 332 is disposed so as tobe rotated by a rotation of the hour chronograph intermediate wheel 330.

The hour chronograph wheel 332 contains an hour chronograph gear wheel 332b, an hour chronograph wheel axle 332c, an hour heart 332d, an hour chronograph wheel clutch spring 332e, an hour chronograph wheel clutch spring clamp seating 332f, an hour chronograph wheel clutch spring reception seating 332g, an hour chronograph wheel clutch ring 332h, an hour chronograph wheel clutch spring clamp seating pin 332j, and an hour chronograph gear wheel reception seating 332k. The hour chronograph wheel clutch spring clamp seating 332f and the hour chronograph gear wheel reception seating 332k are fixed to the hour chronograph wheel axle 332c. The hour chronograph wheel clutch spring clamp seating pin 332j is fixed to the hour chronograph wheel clutch spring clamp seating 332f.

The hour heart 332d and the hour chronograph wheel clutch spring reception seating 332g are fixed to the hour chronograph wheel clutch ring 332h. The hour heart 332d, the hour chronograph wheel clutch spring reception seating 332g and the hour chronograph wheel clutch ring 332h are incorporated into the hour chronograph wheel axle 332c so as to be movable in an axial direction of the hour chronograph wheel axle 332c. The hour heart 332d, the hour chronograph wheel clutch spring reception seating 332g and the hour chronograph wheel clutch ring 332h are comprised so as not to be rotated with respect to the hour chronograph wheel clutch spring clamp seating 332f and the hour chronograph wheel axle 332c by the hour chronograph wheel clutch spring clamp seating pin 332j. The hour chronograph wheel clutch ring 332h is comprised so as to be pushed toward the hour chronograph gear wheel 332b by the hour chronograph wheel clutch spring 332e. The hour chronograph gear wheel 332b is comprised so as to be rotatable with respect to the hour chronograph gear wheel reception seating 332k and the hour chronograph wheel axle 332c.

The hour chronograph gear wheel 332b meshes with the hour chronograph intermediate gear wheel 330b. A rotation center of the hour chronograph wheel 332 is disposed in an intermediate position on the 6 o'clock direction base line KJ3 of the movement 100 (chronograph unit 300). For example, it is preferable that the rotation center of the hour chronograph wheel 332 is disposed on the 6 o'clock direction base line KJ3 in a position existing in a range of 40-70% of a radius of the main plate 102.

If an hour/minute chronograph coupling lever 442 is operated by an operation of a start/stop button 306, a lower face of the hour chronograph wheel clutch ring 332h contacts with an upper face of the hour chronograph gear wheel 332b by a spring force of the hour chronograph wheel clutch spring 332e. Accordingly, under this state, the hour chronograph wheel axle 332c is rotated while interlocking with the hour chronograph gear wheel 332b. Accordingly, under this state, the hour chronograph wheel axle 332c is rotated by a rotation of the hour chronograph intermediate wheel 330. That is, the hour chronograph wheel clutch ring 332h and the hour chronograph wheel clutch spring 332e comprise a “clutch”. At the chronograph measurement operation time, a measurement result of elapsed time of “hour” such as one hour has elapsed is displayed by a chronograph hour hand 338 attached to the hour chronograph wheel axle 332c. After a chronograph measurement stop, if a hammer 464 is operated by an operation of a reset button 308, the hammer 464 rotates the hour heart 332d, and the chronograph hour hand 338 can be returned to zero.

(6) Constitution of Minute Chronograph Train Wheel

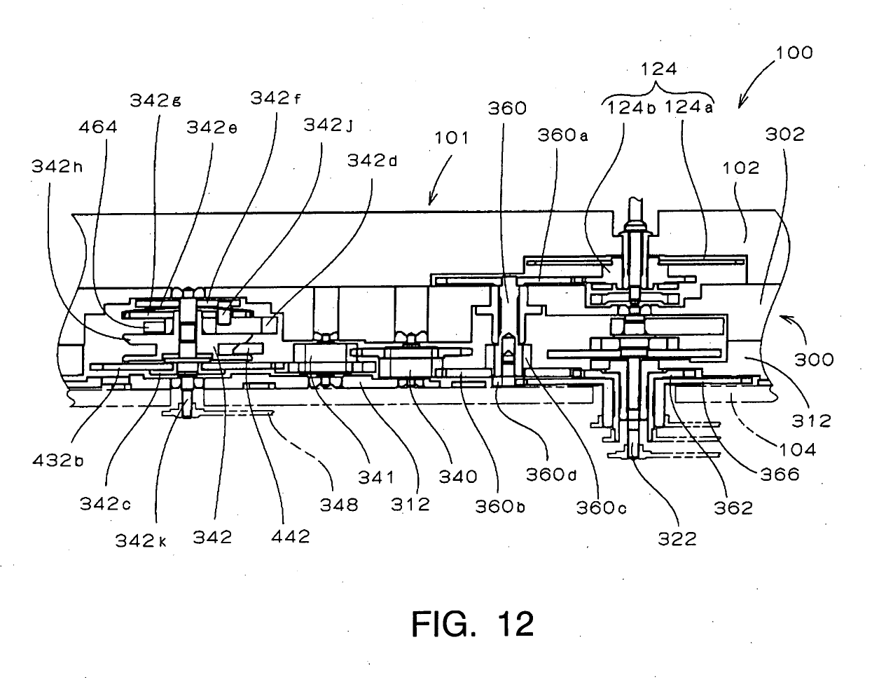

Referring to FIG. 1-FIG. 4, FIG. 8, FIG. 9 and FIG. 12, a minute chronograph intermediate wheel A 340 is disposed so as to be rotatable with respect to the chronograph main plate 302 and the chronograph bridge 312. The minute chronograph intermediate wheel A 340 is disposed so as to be rotated by a rotation of the 2nd minute wheel 360. A pinion portion of the minute chronograph intermediate wheel A 340 meshes with the 2nd minute gear wheel B 360b. A minute chronograph intermediate wheel B 341 is disposed so as to be rotatable with respect to the chronograph main plate 302 and the chronograph bridge 312. The minute chronograph intermediate wheel B 341 is disposed so as to be rotated by a rotation of the minute chronograph intermediate wheel A 340. A pinion portion of the minute chronograph intermediate wheel B 341 meshes with a gear wheel portion of the minute chronograph intermediate wheel A 340. A minute chronograph wheel 342 is disposed so as to be rotatable with respect to the chronograph main plate 302 and the chronograph bridge 312. The minute chronograph wheel 342 is disposed so as to be rotated by a rotation of the minute chronograph intermediate wheel B 341.

The minute chronograph wheel 342 contains a minute chronograph gear wheel 342b, a minute chronograph wheel axle 342c, a minute heart 342d, a minute chronograph wheel clutch spring 342e, a minute chronograph wheel clutch spring clamp seating 342f, a minute chronograph wheel clutch spring reception seating 342g, a minute chronograph wheel clutch ring 342h, a minute chronograph wheel clutch spring clamp seating pin 342j, and a minute chronograph gear wheel reception seating 342k. The minute chronograph wheel clutch spring clamp seating 342f and the minute chronograph gear wheel reception seating 342k are fixed to the minute chronograph wheel axle 342c. The minute chronograph wheel clutch spring clamp seating pin 342j is fixed to the minute chronograph wheel clutch spring clamp seating 342f.

The heart 342d and the minute chronograph wheel spring reception seating 342g are fixed to the minute chronograph wheel clutch ring 342h. The minute heart 342d, the minute chronograph wheel spring reception seating 342g and the minute chronograph wheel clutch ring 342h are incorporated into the minute chronograph wheel axle 342c so as to be movable in an axial direction of the minute chronograph wheel axle 342c. The minute heart 342d, the minute chronograph wheel spring reception seating 342g and the minute chronograph wheel clutch ring 342h are comprised so as not to be rotated with respect to the minute chronograph wheel clutch spring clamp seating 342f and the minute chronograph wheel axle 342c by the minute chronograph wheel clutch spring clamp seating pin 342j. The minute chronograph wheel clutch ring 342h is comprised so as to be pushed toward the minute chronograph gear wheel 342b by the minute chronograph wheel clutch spring 342e. The minute chronograph gear wheel 342b is comprised so as to be rotatable with respect to the minute chronograph gear wheel reception seating 342k and the minute chronograph wheel axle 342c. The minute chronograph gear wheel 342b meshes with a gearwheel portion of the minute chronograph intermediate wheel B 341.

A rotation center of the minute chronograph wheel 342 is disposed in an intermediate position on the 9 o'clock direction base line KJ4 of the movement 100 (chronograph unit 300). For example, it is preferable that the rotation center of the minute chronograph wheel 342 is disposed on the 9 o'clock direction base line KJ4 in a position existing in a range of 40-70% of a radius of the main plate 102. It is preferable to be comprises such that that a distance from a center of the movement 100 (chronograph 300) to the rotation center of the minute chronograph wheel 342 becomes equal to a distance from the center of the movement 100 (chronograph unit 300) to the rotation center of the hour chronograph wheel 332. By this constitution, it is possible to realize a chronograph timepiece capable of performing an hour chronograph display and a minute chronograph display, which are easy to see.

If the hour/minute chronograph coupling lever 442 is operated by the operation of the start/stop button 306, a lower face of the minute chronograph wheel clutch ring 342h contacts with an upper face of the minute chronograph gear wheel 342b by the spring force of the minute chronograph wheel clutch spring 342e. Accordingly, under this state, the minute chronograph wheel axle 342c is rotated while interlocking with the minute chronograph gear wheel 342b. Under this state, the minute chronograph wheel axle 342c is rotated by a rotation of the 2nd minute wheel 360 through rotations of the minute chronograph intermediate wheel A 340 and the minute chronograph intermediate wheel B 341. That is, the minute chronograph clutch ring 342h and the minute chronograph wheel clutch spring 342e comprise a “clutch”. At the chronograph measurement operation time, a measurement result of elapsed time of “minute” such as one minute has elapsed is displayed by a chronograph minute hand 348 attached to the minute chronograph wheel axle 342c. After the chronograph measurement stop, if the hammer 464 is operated by the operation of the reset button 308, the hammer 464 rotates the minute heart 342d, and the chronograph minute hand 348 can be returned to zero.

A rotation center of the 2nd minute wheel 360, a rotation center of the minute chronograph intermediate wheel A 340 and a rotation center of the minute chronograph intermediate wheel B 341 are disposed in the “9 o'clock-12 o'clock region”. The minute chronograph intermediate wheel A 340 and the minute chronograph intermediate wheel B 341 are disposed so as not to overlap with the train wheel constituting the date feed mechanism. The minute chronograph intermediate wheel A 340 and the minute chronograph intermediate wheel B 341 are disposed so as not to overlap with parts constituting a date corrector setting mechanism. By this constitution, it is possible to realize a small and thin type chronograph timepiece.

(7) Constitutions of Second Display Mechanism and Second Chronograph Train Wheel

Referring to FIG. 1-FIG. 4, FIG. 8, FIG. 9 and FIG. 13, a second chronograph intermediate wheel 320 is disposed so as to be rotatable with respect to the chronograph main plate 302 and the chronograph bridge 312. The second chronograph intermediate wheel 320 contains a second chronograph intermediate wheel axle 320b, a second chronograph intermediate gear wheel 320c, a second chronograph intermediate wheel clutch ring 320d, a second chronograph intermediate wheel clutch spring 320e, a second intermediate gear wheel 320f, and a second intermediate gear wheel clamp seating 320g.

The second chronograph intermediate gear wheel 320c is fixed to the second chronograph intermediate wheel axle 320b. The second intermediate gear wheel clamp seating 320g is fixed to the second chronograph intermediate wheel axle 320b. The second intermediate gear wheel 320f is provided rotatably with respect to the second chronograph intermediate wheel axle 320b. The second chronograph intermediate wheel clutch ring 320d and the second chronograph intermediate wheel clutch spring 320e are monolithically formed. The second chronograph intermediate wheel clutch ring 320d and the second chronograph intermediate wheel clutch spring 320e are incorporated into the second chronograph intermediate wheel axle 320b so as to be movable in an axial direction of the second chronograph intermediate wheel axle 320b. The second chronograph intermediate wheel clutch ring 320d is comprises so as to be pushed toward the second intermediate gear wheel 320f by the second chronograph intermediate wheel clutch spring 320e.

A second transmission wheel 318 is fixed to the second wheel & pinion 138. The second transmission wheel 318 is disposed between the minute train cover 278 and the chronograph main plate 302. The second intermediate gear wheel 320f is rotated by a rotation of the second transmission wheel 318. A second wheel 352 is rotated by a rotation of the second intermediate gear wheel 320f. By a second hand (small second hand) 354 attached to the second wheel 352, “second” at the present time is displayed. That is, the second wheel 352 comprises a second display mechanism. A rotation center of the second wheel 352 is disposed in an intermediate position on the 3 o'clock direction base line KJ2 of the movement 100 (chronograph unit 300). For example, it is preferable that the rotation center of the second wheel 352 is disposed on the 3 o'clock direction base line KJ2 in a position existing in a range of 40-70% of a radius of the main plate 102.

It is preferable that the second wheel 352 is disposed so as not to overlap with the date feed mechanism, and disposed so as not to overlap with the date corrector setting mechanism. By this constitution, it is possible to realize a small and thin type chronograph timepiece.

It is preferable to be comprised such that a distance from the center 402 of the movement 100 (chronograph unit 300) to a rotation center of the second wheel 352 becomes equal to a distance from the center 402 of the movement 100 (chronograph unit 300) to a rotation center of the minute chronograph wheel 342, and a distance from the center 402 of the movement 100 (chronograph unit 300) to a rotation center of the hour chronograph wheel 332. By this constitution, it is possible to realize a chronograph timepiece capable of performing a second display, an hour chronograph display and a minute chronograph display, which are easy to see.

If a chronograph coupling lever A 444 and a chronograph coupling lever B 446 are operated by the operation of the start/stop button 306, the second chronograph intermediate wheel clutch ring 320d is pushed to the second intermediate gear wheel 320f by the spring force of the second chronograph intermediate wheel clutch spring 320e. Under this state, the second chronograph intermediate gear wheel 320c and the second chronograph intermediate wheel axle 320b are rotated while interlocking with the second intermediate gear wheel 320f. That is, under this state, the second chronograph intermediate gear wheel 320c is rotated by a rotation of the second transmission wheel 318. The second chronograph intermediate wheel clutch ring 320d and the second chronograph intermediate wheel clutch spring 320e comprise a “clutch”.

A second chronograph wheel 322 is rotated by a rotation of the second chronograph intermediate gear wheel 320c. The second chronograph wheel 322 contains a second chronograph gear wheel 322b, a second chronograph wheel axle 322c, a second heart 322d, and a stop lever plate 322f. The rotation center 402 of the second chronograph wheel 322 is the same as a rotation center of the second wheel & pinion 138, is the same as a rotation center of the minute driving wheel & pinion 124, is the same as a rotation center of the 2nd minute driving wheel & pinion 362, and is the same as a rotation center of the hour wheel 366. The rotation center of the minute driving wheel & pinion 124 and the rotation center of the hour wheel 366 are disposed in the center 402 of the movement 100 (chronograph unit 300).

It is preferable that a rotation center of the second chronograph intermediate wheel 320 is disposed so as to exist on the 3 o'clock direction base line KJ2 of the movement 100. The rotation center of the second chronograph intermediate wheel 320 may be disposed so as to exist in the “12 o'clock-3 o'clock region” of the movement 100, or may be disposed so as to exist in the “3 o'clock-6 o'clock region” of the movement 100. It is especially preferable that the second chronograph intermediate wheel 320 is disposed so as to overlap with the 3 o'clock direction base line KJ2 of the movement 100. By this constitution, it is possible to realize a small and thin type chronograph timepiece.

At the chronograph measurement operation time, a measurement result of elapsed time of “second” such as one second has elapsed is displayed by a chronograph second hand 324 attached to the second chronograph wheel axle 322c. After the chronograph measurement stop, if the hammer 464 is operated by the operation of the reset button 308, the hammer 464 rotates the second heart 322d, and the chronograph second hand 324 can be returned to zero.

(8) Constitution of Calendar Corrector Mechanism

Referring to FIG. 1, FIG. 6-FIG. 9 and FIG. 14, if the winding stem 108 is drawn out along its rotation axis direction to a state existing in the 2nd winding stem position (1st step), the setting lever 280 is rotated. Under this state, if the winding stem 108 is rotated, the setting wheel 266 is rotated through a rotation of the clutch wheel 276. It is comprised such that the date corrector setting transmission wheel B 284 is rotated by a rotation of the setting wheel 266 through a rotation of the date corrector setting transmission wheel A 282. In one end of the date corrector setting transmission wheel B 284, there is comprised the date corrector setting transmission wheel C 286 so as to be rotated together with the date corrector setting transmission wheel B 284. Accordingly, it is comprised such that the date corrector setting wheel 288 is rotated by a rotation of the date corrector setting transmission wheel B 284 through a rotation of the date corrector setting transmission wheel C 286. A rotation center of the date corrector setting wheel 288 and a rotation center of the date corrector setting transmission wheel C 286 are disposed in the “12 o'clock-3 o'clock region”. The date corrector setting wheel 288 is disposed so as not to overlap with the train wheel constituting the chronograph mechanism. That is, the date corrector setting mechanism is disposed in the “12 o'clock-3 o'clock region”. The date corrector setting mechanism is disposed so as not to overlap with the date feed mechanism. By this constitution, it is possible to realize a small and thin type chronograph timepiece.

The date corrector setting wheel 288 is comprised such that, if it is rotated in one direction, the date indicator 376 can be rotated. In this constitution, it is possible to rotate the date indicator 376 to thereby perform a date correction by drawing out the winding stem 108 to the 2nd winding stem position (1st step) and rotating the winding stem 108 in one direction.

(9) Chronograph Operation Mechanism

Next, it is explained about a chronograph operation mechanism.

(9-1) State That Chronograph Measurement is not Operated

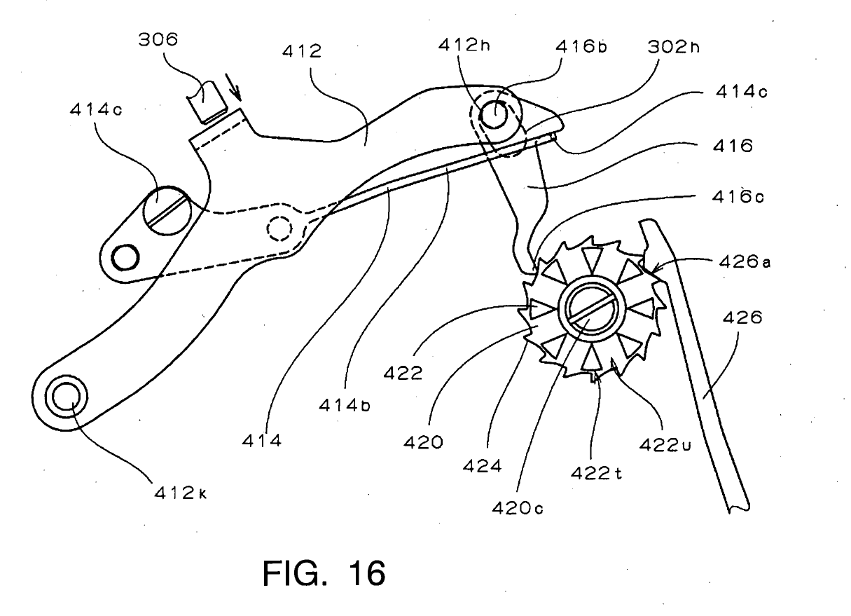

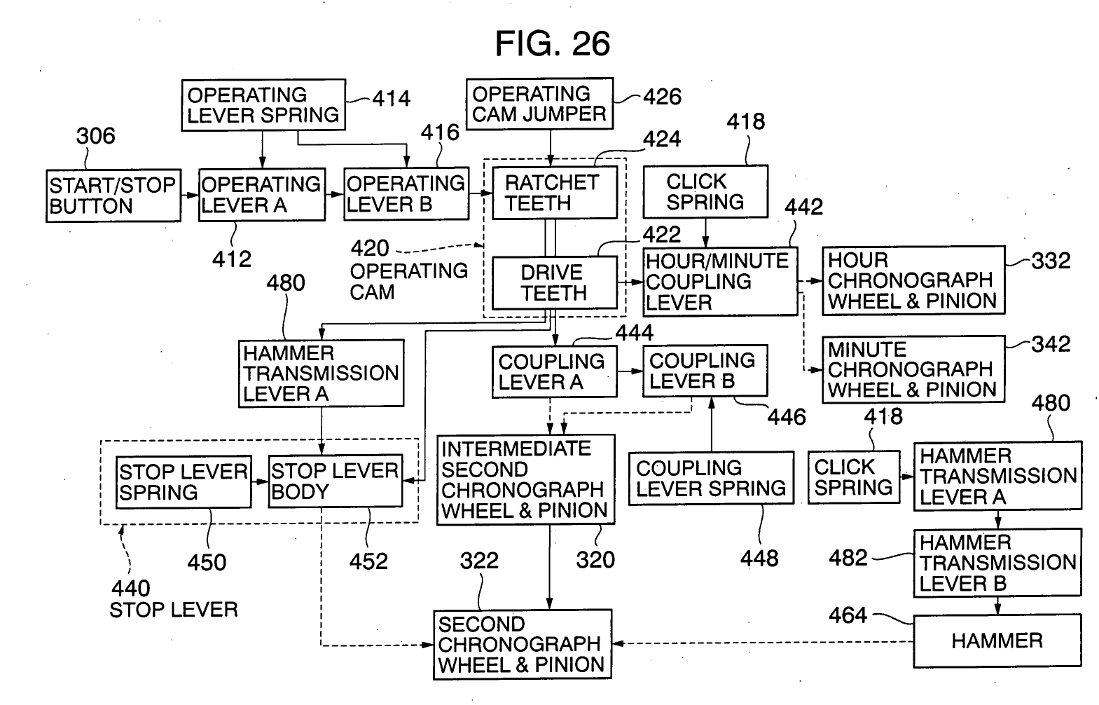

Referring to FIG. 1, FIG. 16 and FIG. 26, it is explained about a constitution of a chronograph operation mechanism under a state that a chronograph measurement is not operated. The start/stop button 306 is provided in the 2 o'clock direction of the movement 100. It is preferable that a center axis of the start/stop button 306 is disposed in the 2 o'clock direction of the movement 100, but it may be disposed in a position, of other than the 2 o'clock direction, between the 1 o'clock direction and the 3 o'clock direction of the movement 100. The start/stop button 306 is disposed so as to act on parts existing in the “12 o'clock-3 o'clock region” of the movement 100.

It is comprised such that an operating lever A 412 can be rotated by pushing the start/stop button 306 in a direction indicated by an arrow mark. A position where the operating lever A 412 contacts with the start/stop button 306 exists in the “12 o'clock 3 o'clock region” of the movement 100. The operating lever A 412 is disposed so as to be rotatable with an operating lever A rotation axle 412k being made a rotation center. An operating lever spring 414 has a spring portion 414b. A tip part 414c of a spring portion 414b of the operating lever spring 414 pushes the operating lever A 412 toward the start/stop button 306 so as to rotate in a counterclockwise direction. The operating lever spring 414 is attached to the chronograph main plate 302 by an operating lever spring clamp screw 414c. An operating lever B pin 416b is fixed to an operating lever B 416. One part of the operating lever B pin 416b is disposed in a circular hole 412h provided in the operating lever A 412, and other one part is guided by and disposed in a long hole shape guide hole 302h provided in the chronograph main plate 302.

It is comprised such that, after the start/stop button 306 has been pushed, if a finger is separated form the start/stop button 306, the operating lever 412 is rotated in the counterclockwise direction by a spring force of the operating lever spring 414. It is comprised such that the start/stop button 306 is returned to its original position by a spring force of a return spring incorporated in an armoring case.

It is comprised such that the reset button 308 is provided in the 4 o'clock direction of the movement 100, and a hammer operating lever A 480 can be rotated by pushing the reset button 308 in a direction indicated by an arrow mark. It is comprised such that, after the reset button 308 has been pushed, if a finger is separated from the reset button 308, the hammer operating lever A 480 is rotated in a clockwise direction by a spring force of a click spring 418. It is comprised such that the reset button 308 is returned to its original position by the spring force of the return spring incorporated in the armoring case. It is preferable that a center axis of the reset button 308 is disposed in the 4 o'clock direction of the movement 100, but it may be disposed in a position, of other than the 4 o'clock direction, between the 3 o'clock direction and the 6 o'clock direction of the movement 100. The reset button 308 is disposed so as to act on parts existing in the “3 o'clock-6 o'clock region” of the movement 100. It is comprised such that a position where the hammer operating lever A 480 contacts with the reset button 308 exists in the “3 o'clock-6 o'clock region” of the movement 100.

An operation cam 420 has drive teeth 422 and ratchet teeth 424, and is rotatably provided. A rotation center of the operation cam 420 is disposed in the “3 o'clock-6 o'clock region” of the movement 100. The ratchet teeth 424 are sixteen in teeth number. The drive teeth 422 are eight in teeth number, and this is ½ of the teeth number of the ratchet teeth 424. Accordingly, if the ratchet teeth 424 are fed by one pitch, the drive teeth 422 are fed by ½ pitch. The operation cam 420 is attached to the chronographmain plate 302 by an operation cam clamp screw 420c so as to be rotatable. The tip part 414c of the spring portion 414b of the operation lever spring 414 further pushes a tip part 416c of the operating lever B 416 toward the ratchet teeth 424 of the operation cam 420 such that the operating lever B 416 is rotated in the counterclockwise direction with the operating lever B pin 416b being made a rotation center.

Seeing about one place corresponding to an outer periphery of the drive teeth 422, it is comprised such that, every time the ratchet teeth 424 are fed by one pitch, a top part 422t and a valley part 422u of the drive teeth 422 are alternately positioned. So long as the teeth number of the ratchet teeth 424 is twice the teeth number of the drive teeth 422, the teeth number of the ratchet teeth 424 may not be sixteen. However, the teeth number of the ratchet teeth 424 is an even number.

An operation cam jumper 426 having a spring part is provided. A setting part 426a of the operation cam jumper 426 sets the ratchet teeth 424, thereby determining a position concerning a rotation direction of the operation cam 420. Accordingly, by the ratchet teeth 424 and the operation cam jumper 426, the operation cam 420 is rotated by every 360/16 degrees and surely positioned in that position. The tip part 416c of the operating lever B 416 is disposed so as to contact with the ratchet teeth 424.

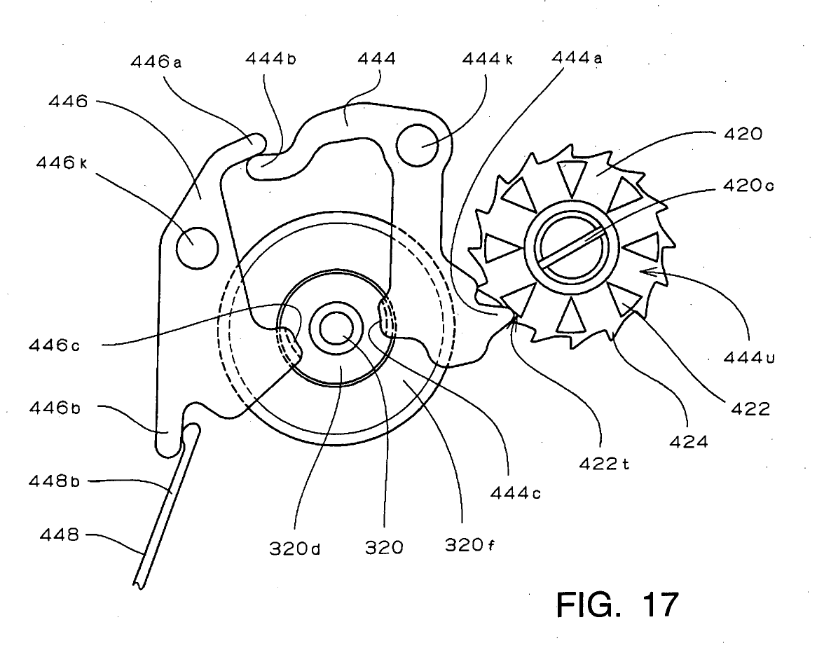

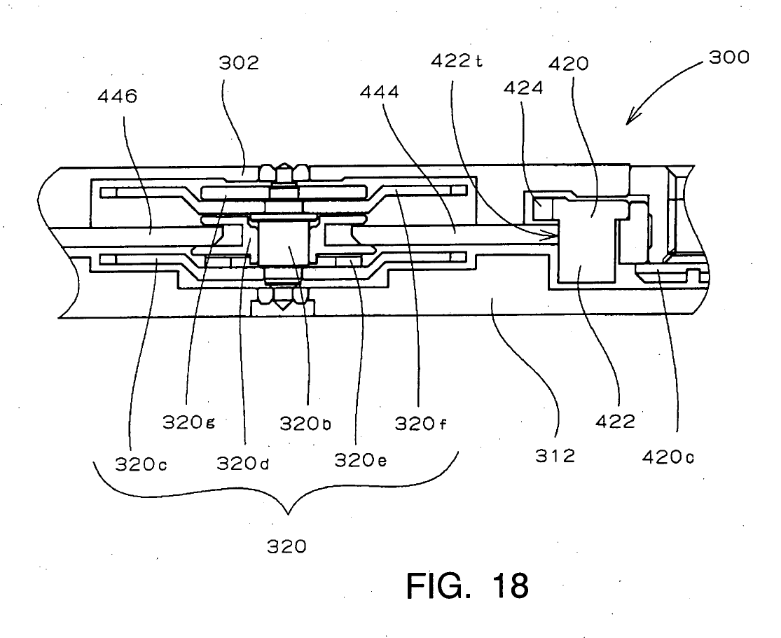

Referring to FIG. 1, FIG. 17, FIG. 18 and FIG. 26, a chronograph coupling lever A 444 is provided rotatably about a chronograph coupling lever A rotation axle 444k. The chronograph coupling lever A 444 has a chronograph coupling lever tip part 444a, a chronograph coupling lever B contact part 444b, and a clutch ring contact part 444c. The chronograph coupling lever tip part 444a contacts with an outer periphery part of the top part 422t of the drive teeth 422.

A chronograph coupling lever B 446 is provided rotatably about a chronograph coupling lever B rotation axle 446k. The chronograph coupling lever B 446 has a chronograph coupling lever A contact part 446a, a chronograph coupling lever spring contact part 446b, and a clutch ring contact part 446c. A chronograph coupling lever spring 448 has a spring portion 448b. The spring portion 448b of the chronograph coupling lever spring 448 pushes the chronograph coupling lever spring contact part 446b of the chronograph coupling lever B 446 such that the chronograph coupling lever B 446 is rotated in the clockwise direction with a chronograph coupling lever B rotation axle 446k being made a rotation center. The chronograph coupling lever B 446 pushes the chronograph coupling lever tip part 444a of the chronograph coupling lever A 444 to the outer periphery part of the top part 422t of the drive teeth 422 such that the chronograph coupling lever A 444 is rotated in the counterclockwise direction with the chronograph coupling lever A rotation axle 444k being made a rotation center.

The clutch ring contact part 444c of the chronograph coupling lever A 444 and the clutch ring contact part 446c of the chronograph coupling lever B 446 contact with the second chronograph intermediate wheel clutch ring 320d of the second chronograph intermediate wheel 320, thereby making the clutch OFF. Accordingly, under this state, even if the second intermediate gear wheel 320f is rotated, the second chronograph intermediate gear wheel 320c is not rotated, so that the chronograph second hand 324 is not rotated.

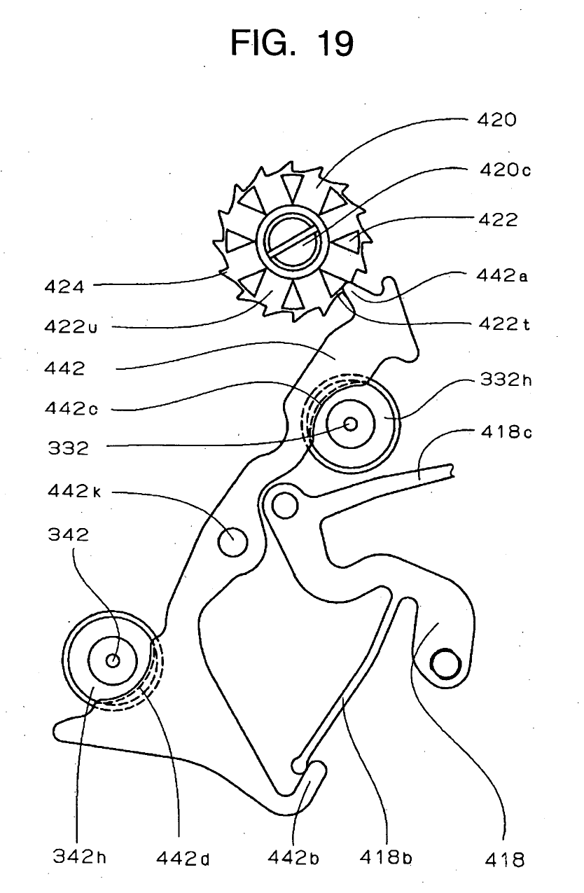

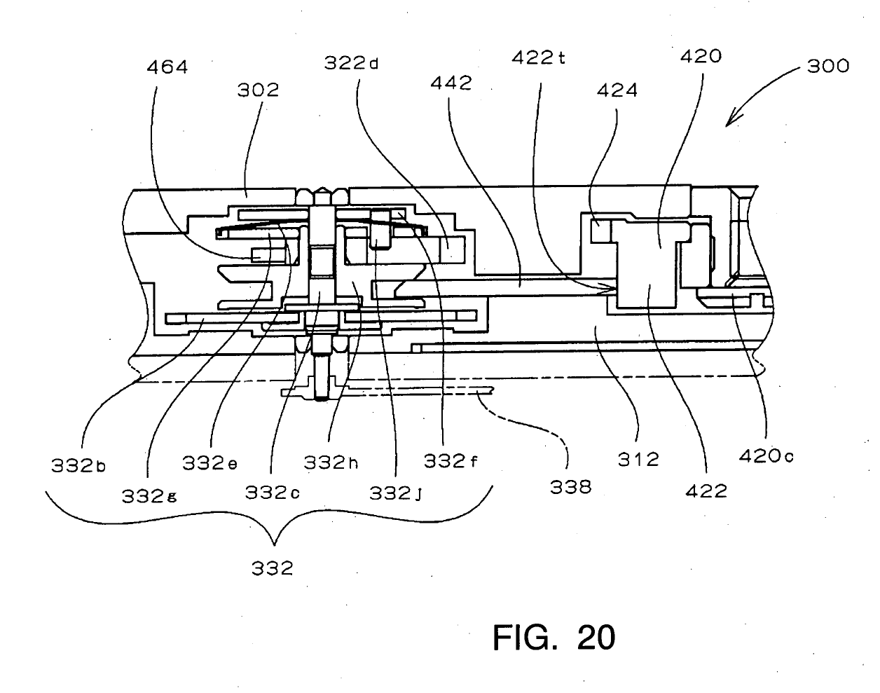

Referring to FIG. 1, FIG. 19, FIG. 20 and FIG. 26, an hour/minute chronograph coupling lever 442 is disposed rotatably about an hour/minute chronograph coupling lever rotation axle 442k. The hour/minute chronograph coupling lever 442 has anhour/minute chronograph coupling lever tip part 442a, a click spring contact part 442b, an hour clutch ring contact part 442c, and a minute clutch ring contact part 442d. The hour/minute chronograph coupling lever tip part 442a contacts with the outer periphery part of the top part 422t of the drive teeth 422.

The click spring 418 has an hour/minute chronograph coupling lever spring portion 418b, and a hammer operating lever spring portion 418c. The hour/minute chronograph coupling lever spring portion 418b of the click spring 418 pushes the click spring contact part 442b of the hour/minute chronograph coupling lever 442 such that the hour/minute chronograph coupling lever 442 is rotated in the counterclockwise direction with the hour/minute chronograph coupling lever rotation axle 442k being made a rotation center. The hour/minute chronograph coupling lever 442 pushes the hour/minute chronograph coupling lever tip part 442a of the hour/minute chronograph coupling lever 442 to the outer periphery part of the top part 422t of the drive teeth 422 such that hour/minute chronograph coupling lever 442 is rotated in the clockwise direction with the hour/minute chronograph coupling lever rotation axle 442k being made a rotation center.

The hour clutch ring contact part 442c of the hour/minute chronograph coupling lever 442 contacts with the hour chronograph wheel clutch ring 332h of the hour chronograph wheel 332, thereby making the clutch OFF. Accordingly, under this state, even if the hour chronograph gear wheel 332b is rotated, the hour chronograph wheel axle 332c is not rotated, so that the chronograph hour hand 338 is not rotated. Further, the minute clutch ring contact part 442d of the hour/minute chronograph coupling lever 442 contacts with the minute chronograph wheel clutch ring 342h of the minute chronograph wheel 342, thereby making the clutch OFF. Accordingly, under this state, even if the minute chronograph gear wheel 342b is rotated, the minute chronograph wheel axle 342c is not rotated, so that the chronograph minute hand 348 is not rotated.

(9-2) State That Chronograph Measurement is Operated

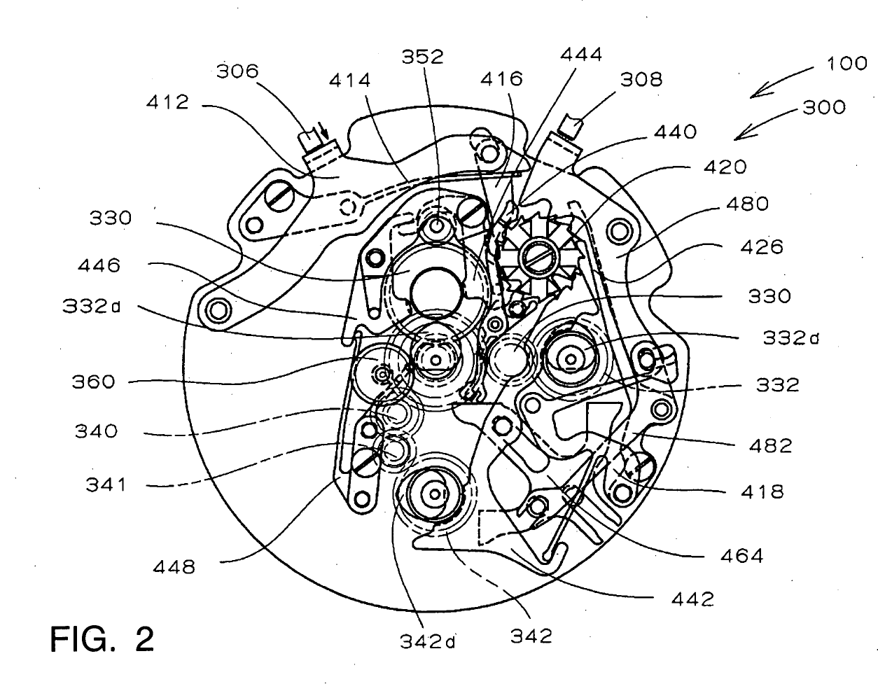

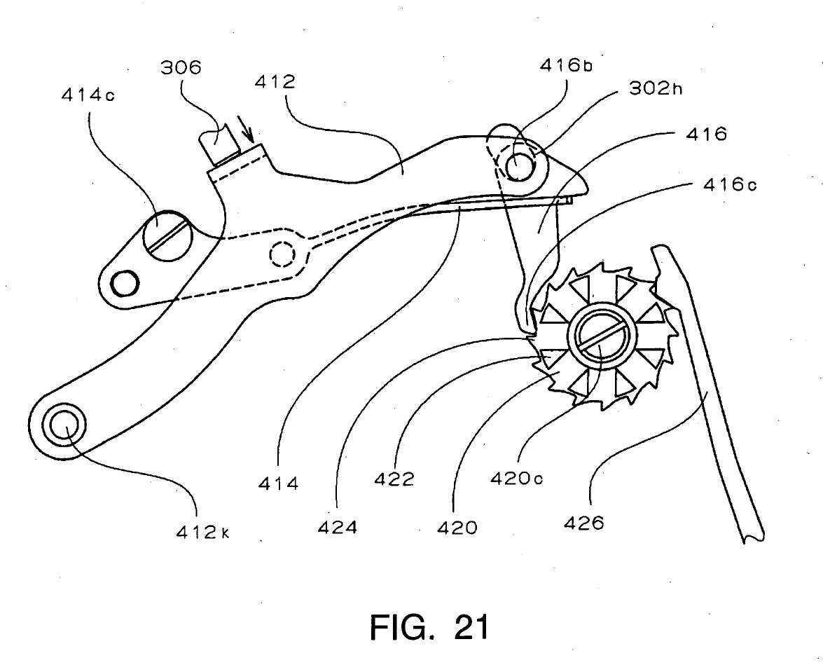

Referring to FIG. 2 and FIG. 21, it is explained about the constitution of the chronograph operation mechanism under a state that the chronograph measurement is operated. If the start/stop button 306 is pushed in the direction indicated by the arrow mark, the operating lever A 412 is rotated in the clockwise direction with the operating lever A rotation axle 412k being made a rotation center. The operating lever B pin 416b of the operating lever B 416 is guided by the guide hole 302h of the chronograph main plate 302, and the operating lever B 416 is moved.

If the start/stop button 306 is pushed and the operating lever B 416 is moved, the tip part 416c of the operating lever B 416 rotates the ratchet teeth 424 of the operation cam 420 by one pitch in the counterclockwise direction. The setting part 426a of the operation cam jumper 426 sets the ratchet teeth 424, thereby determining the position concerning the rotation direction of the operation cam 420. Accordingly, if the start/stop button 306 is pushed and the operating lever B 416 is moved, the operation cam 420 is rotated by every 360/16 degrees.

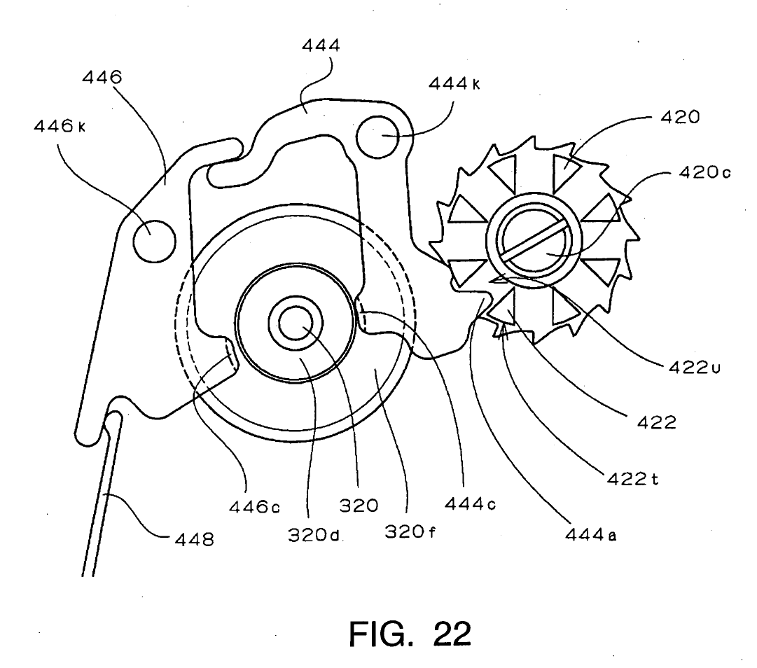

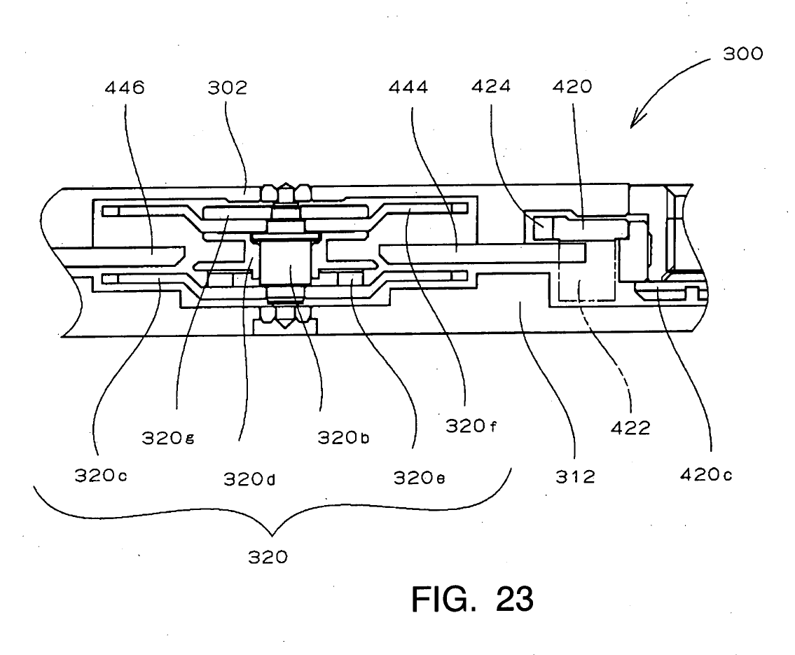

Referring to FIG. 2, FIG. 22 and FIG. 23, if the operation cam 420 is rotated by 360/16 degrees, the chronograph coupling lever 444 is rotated about the chronograph coupling lever A rotation axle 444k, and the chronograph coupling lever tip part 444a is positioned in the valley part 422u of the drive teeth 422. Further, if the chronograph coupling lever A 444 is rotated, the chronograph coupling lever B 446 is also rotated about the chronograph coupling lever B rotation axle 446k.

If the chronograph coupling lever A 444 is rotated, the clutch ring contact part 444c of the chronograph coupling lever A 444 is separated from the second chronograph intermediate wheel clutch ring 320d of the second chronograph intermediate wheel 320, thereby making the clutch ON. If the chronograph coupling lever B 446 is rotated, the clutch ring contact part 446c of the chronograph coupling lever B 446 is separated from the second chronograph intermediate wheel clutch ring 320d of the second chronograph intermediate wheel 320, thereby making the clutch ON. Accordingly, under this state, if the second chronograph intermediate wheel axle 320b is rotated, the second chronograph intermediate gear wheel 320c is rotated, so that the chronograph second hand 324 is also rotated.

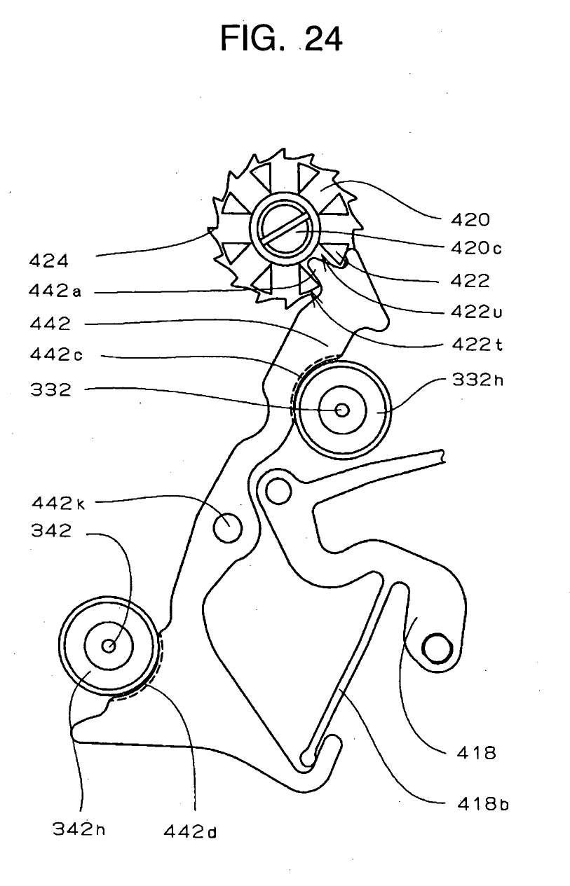

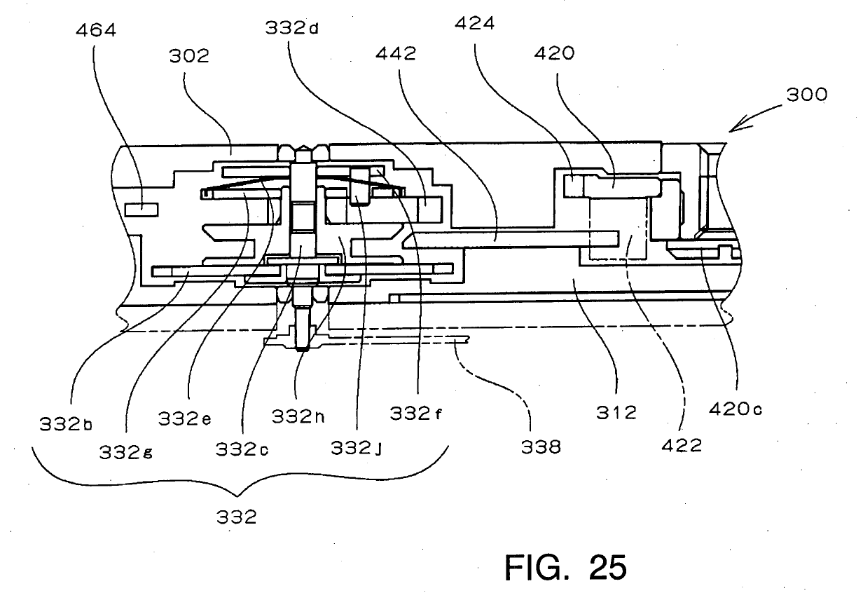

Referring to FIG. 2, FIG. 24 and FIG. 25, if the operation cam 420 is rotated by 360/16 degrees, the hour/minute chronograph coupling lever 442 is rotated about the hour/minute chronograph coupling lever rotation axle 442k, and the hour/minute chronograph coupling lever tip part 442a is positioned in the valley part 422t of the drive teeth 422. If the hour/minute chronograph coupling lever 442 is rotated, the hour clutch ring contact part 442c of the hour/minute chronograph coupling lever 442 is separated from the hour chronograph wheel clutch ring 332h of the hour chronograph wheel 332, thereby making the clutch ON. Accordingly, under this state, if the hour chronograph gear wheel 332b is rotated, the hour chronograph wheel axle 332c is rotated, so that the chronograph hour hand 338 is also rotated. Further, if the hour/minute chronograph coupling lever 442 is rotated, the minute clutch ring contact part 442d of the hour/minute chronograph coupling lever 442 is separated from the minute chronograph wheel clutch ring 342h of the minute chronograph wheel 342, thereby making the clutch ON. Accordingly, under this state, if the minute chronograph gear wheel 342b is rotated, the minute chronograph wheel axle 342c is rotated, so that the chronograph minute hand 348 is also rotated.

(9-3) Constitution and Operation of Stop Lever

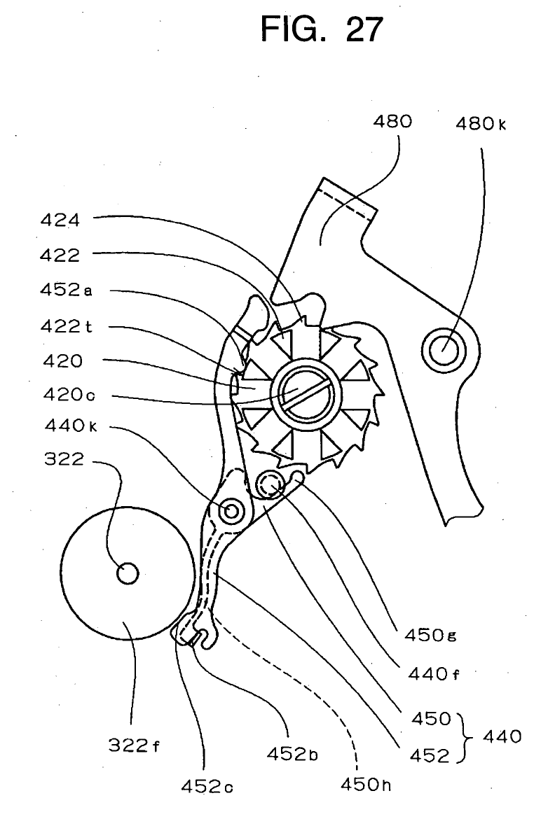

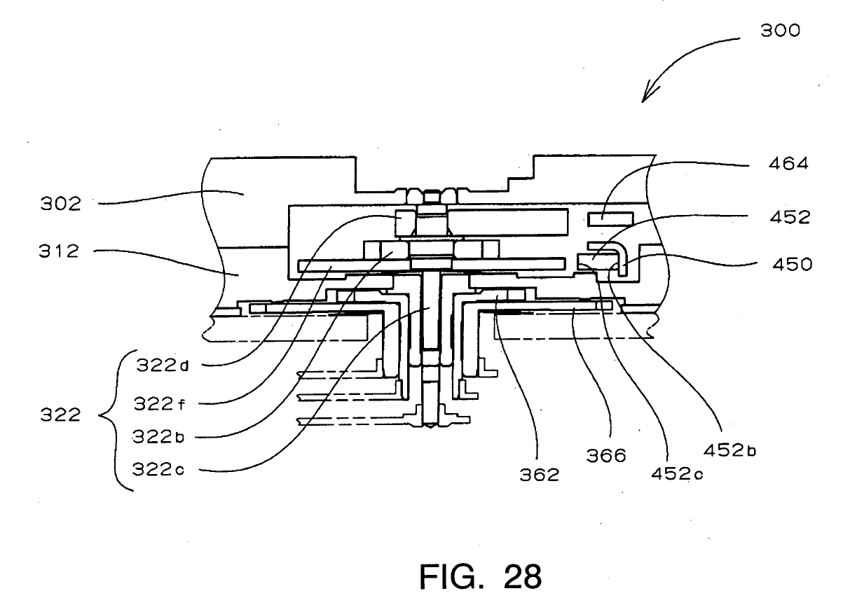

Referring to FIG. 2, FIG. 27 and FIG. 28, a stop lever 440 contains a stop lever spring 450, and a stop lever body 452. The stop lever body 452 is provided rotatably about a stop lever rotation axle 440k. A stop lever spring peg pin 440f is provided in the chronograph main plate 302. The stop lever spring 450 contains a positioning part 450g, and a spring portion 450h. The stop lever body 452 contains an operation cam contact part 452a, a stop lever spring contact part 452b, and a setting part 452c. As to the stop lever spring 450, a tip part of the spring portion 450h pushes the stop lever spring contact part 452b such that the stop lever body 452 is rotated in the clockwise direction.

Under the state that the chronograph measurement is operated, the operation cam contact part 452a of the stop lever body 452 contacts with the outer periphery part of the top part 422t of the drive teeth 422. Accordingly, under this state, the setting part 452c of the stop lever body 452 is separated from the stop lever plate 322f. Accordingly, under this state, the second chronograph axle 322c is not set.

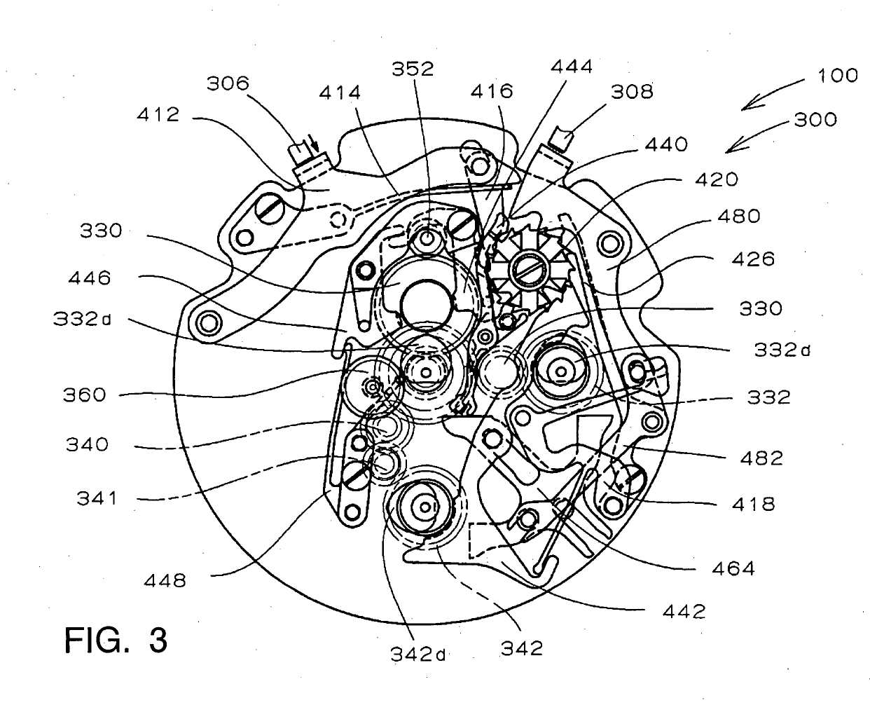

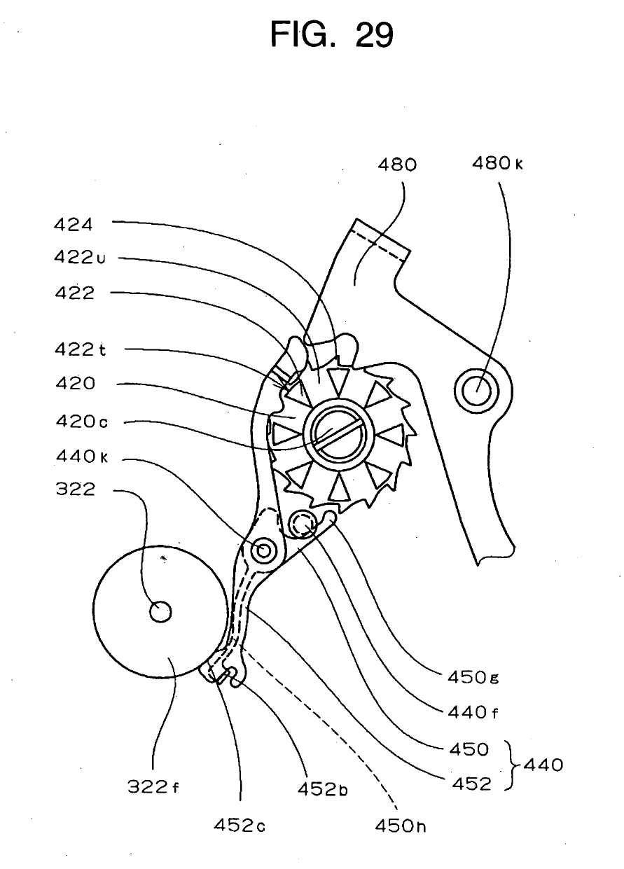

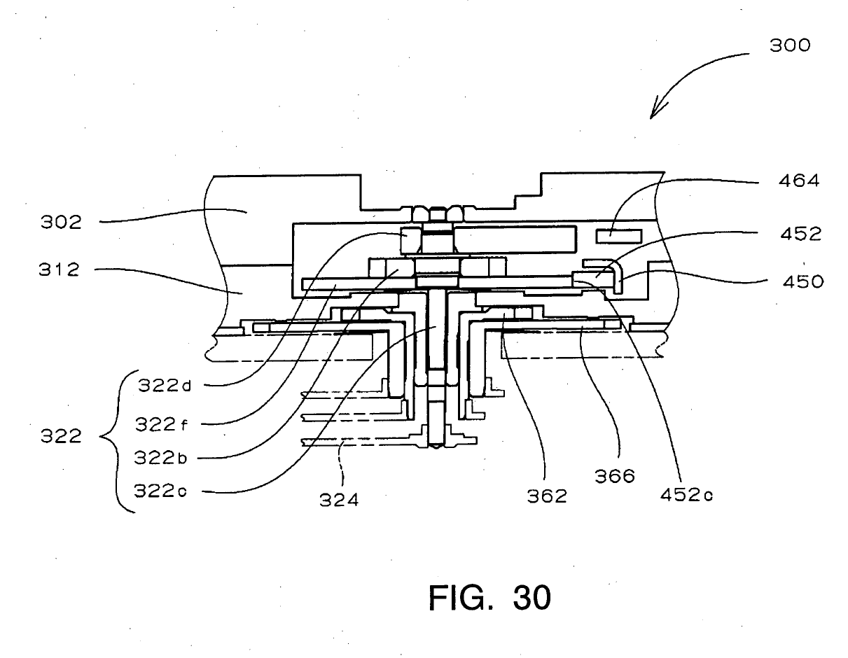

Referring to FIG. 3, FIG. 29 and FIG. 30, under a state that the chronograph measurement is stopped, if the operation cam 420 is rotated by 360/16 degrees, the operation cam contact part 452a of the stop lever body 452 is positioned within the valley part 422u of the drive teeth 422. Accordingly, under this state, the setting part 452c of the stop lever body 452 contacts with the stop lever plate 322f by a spring force of the spring portion 450h of the stop lever spring 450. Accordingly, under this state, the second chronograph axle 322c is set, so that the chronograph second hand 324 cannot rotate.

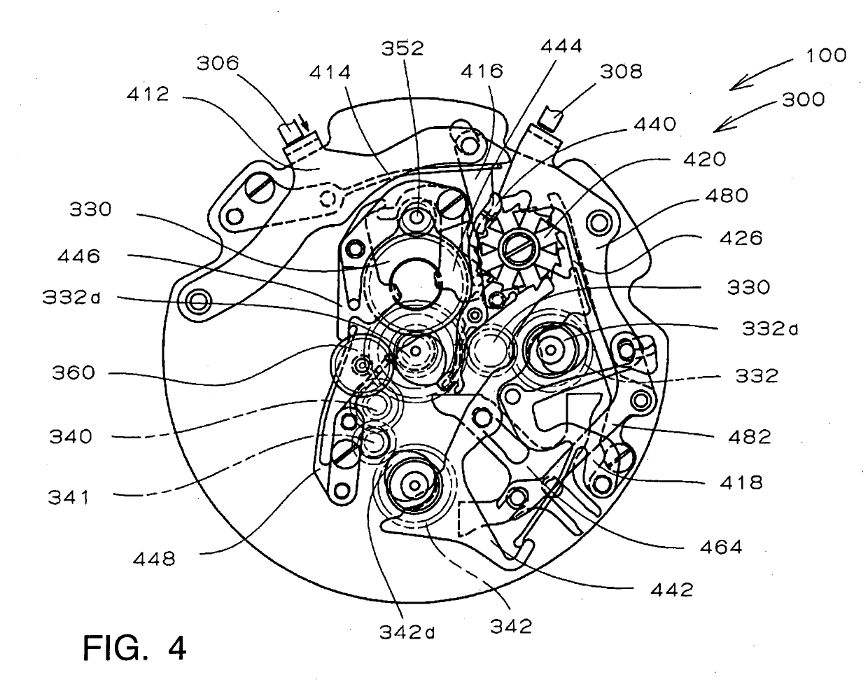

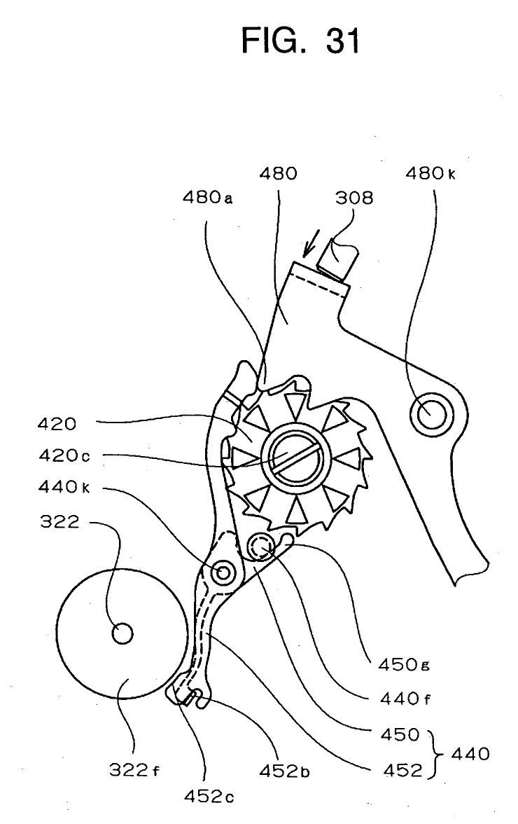

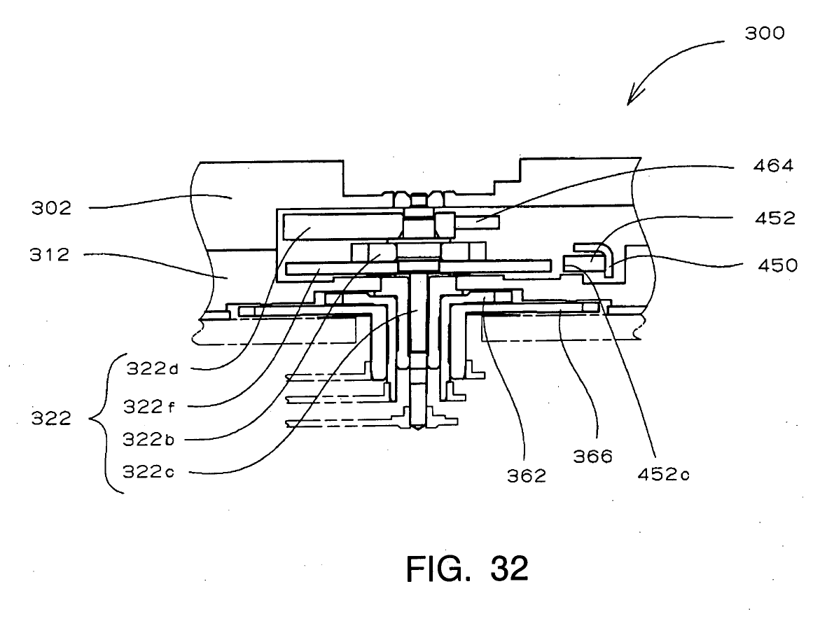

Referring to FIG. 4, FIG. 31 and FIG. 32, under a reset state that the reset button 308 is pushed in the direction indicated by the arrow mark and the hammer operating lever A 480 is rotated in the counterclockwise direction, a stop lever contact part 480a of the hammer operating lever A 480 pushes the stop lever body 452. Accordingly, the stop lever body 452 is rotated in the counterclockwise direction, and the setting part 452c of the stop lever body 452 is separated from the stop lever plate 322f. Accordingly, under this state, the second chronograph axle 322c is not set.

(9-4) Constitution and Operation of Hammer

Referring to FIG. 1-FIG. 3 and FIG. 33-FIG. 35, the hammer operating lever A 480 contains the stop lever contact part 480a, an operation cam contact part 480b, and a hammer operating lever operation pin 480c. The hammer operating lever A 480 is provided rotatably about the hammer operating lever A rotation axle 480k. A hammer operating lever B 482 contains a hammer operating lever operation hole 482a, and a hammer operation part 482c. The hammer operating lever B 482 is provided rotatably about a hammer operating lever B rotation axle 482k. One part of the hammer operating lever operation pin 480c is disposed within the hammer operating lever operation hole 482a. A hammer operating lever guide hole 480h is provided in the chronograph main plate 302. One part of the hammer operating lever operation pin 480c s disposed within the hammer operating lever guide hole 480h.

A hammer 464 contains a hammer operation pin 464a, a hammer guide hole 464b, a hammer guide part 464c, an hour heart contact part 464d, a second heart contact part 464e, and a minute heart contact part 464f. A hammer guide pin A 464h and a hammer guide pin B 464j are provided in the chronograph main plate 302. The hammer operation pin 464a is disposed within the hammer operation part 482c. The hammer guide pin A 464h is disposed within the hammer guide hole 464b. The hammer guide pin B 464j is disposed within the hammer guide part 464c. The hammer 464 is provided movably by being guided by the hammer guide pin A 464h and the hammer guide pin B 464j.

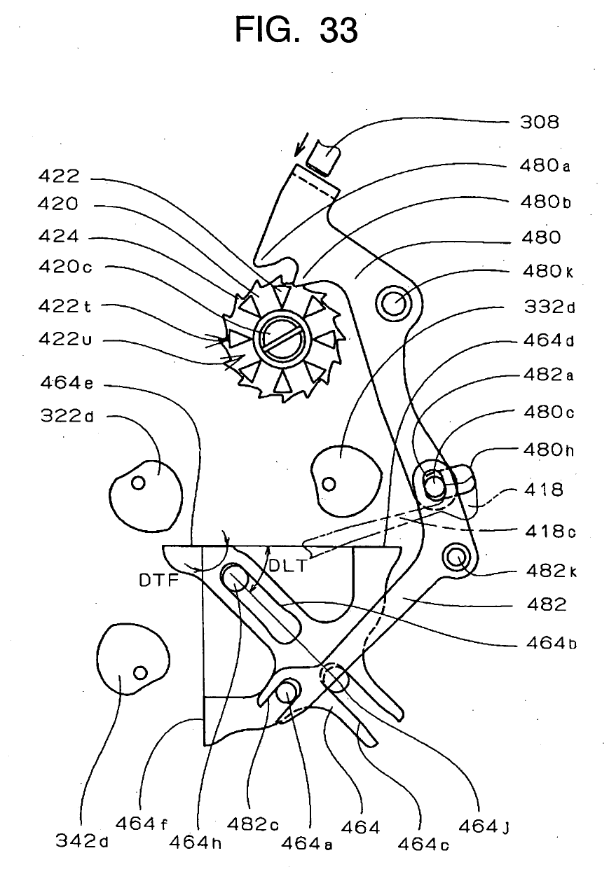

Referring to FIG. 33, the hammer operating lever spring portion 418c of the click spring 418 pushes the hammer operating lever operation pin 480c of the hammer operating lever A 480 such that the hammer operating lever A 480 is rotated in the clockwise direction with the hammer operating lever A rotation axle 480k being made a rotation center.

Under the state that the chronograph measurement is operated and under the state that the chronograph measurement is stopped, the hour heart contact part 464d is separated from the hour heart 332d, the second heart contact part 464e is separated from the second heart 322d, and the minute heart contact part 464f is separated from the minute heart 342d.

Referring to FIG. 1, a rotation center of the operation cam 420 is positioned in the “3 o'clock-6 o'clock region”. A rotation center of the operating lever A 412 is positioned in the “12 o'clock-3 o'clock region”. A rotation center of the chronograph coupling lever A 444 is positioned in the “3 o'clock-6 o'clock region”. A rotation center of the hour/minute chronograph coupling lever 442 is positioned in the “6 o'clock-9 o'clock region”. A rotation center of the hammer operating lever A 480 is positioned in the “3 o'clock-6 o'clock region”. A rotation center of the hammer operating lever B 482 is positioned in the “6 o'clock-9 o'clock region”. The hammer 464 is positioned in the “6 o'clock-9 o'clock region”.

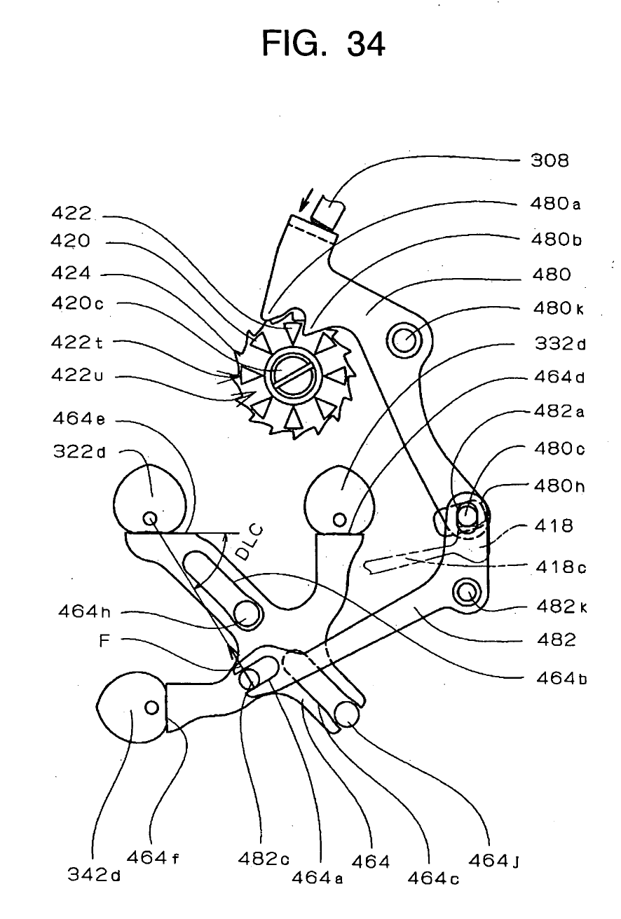

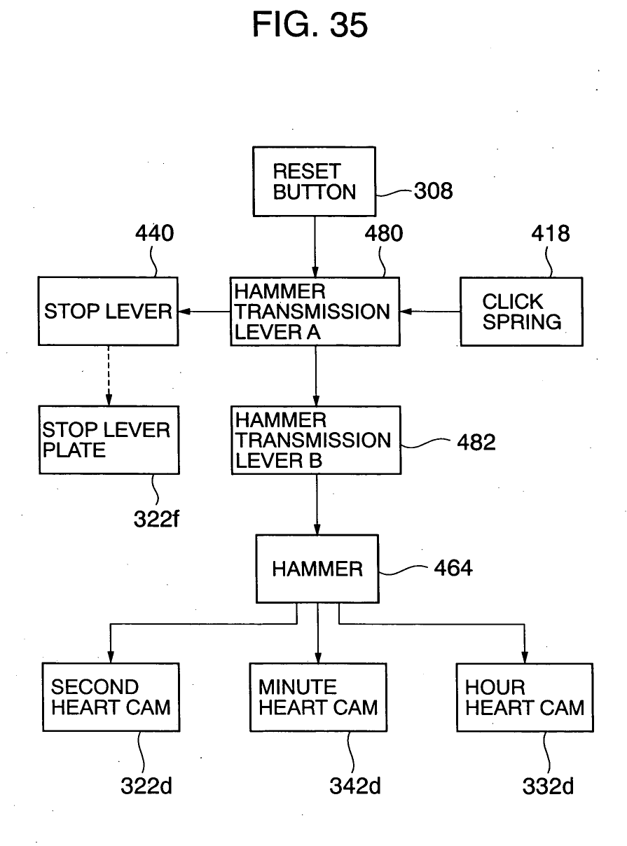

Referring to FIG. 4, FIG. 34 and FIG. 35, under the reset state that the reset button 308 is pushed in the direction indicated by the arrow mark and the hammer operating lever A 480 is rotated in the counterclockwise direction, the operation cam contact part 480b of the hammer operating lever A 480 is positioned within the valley part 422u of the drive teeth 422 of the operation cam 420. By the fact that the hammer operating lever operation pin 480c of the hammer operating lever A 480 is moved, the hammer operating lever B 482 is rotated in the clockwise direction about the hammer operating lever B rotation axle 482k.

By the fact that the hammer operation part 482c of the hammer operating lever B 482 is moved, a force is applied to the hammer operation pin 464a. Accordingly, the hammer 464 is linearly moved toward the hour heart 332d, the second heart 322d and the minute heart 342d while being guided by the hammer guide pin A 464h and the hammer guide pin B 464j. And, the hour heart contact part 464d contacts with the hour heart 332d, the second heart contact part 464e contacts with the second heart 322d, and the minute heart contact part 464f contacts with the minute heart 342d. Accordingly, by operating the reset button 308, the hour heart 332d, the second heart 322d and the minute heart 342d can be returned to zero. Under this state, all of the chronograph hour hand 338, the chronograph minute hand 348 and the chronograph second hand 324 indicate “zero position” (refer to FIG. 15).

It is comprised such that when the hammer 464 contacts with the hour heart 332d, the second heart 322d and the minute heart 342d, a position of the hammer 464 is determined only by the hour heart 332d, the second heart 322d and the minute heart 342d. That is, it is comprised such that the position of the hammer 464 is “self-aligned” by the three hearts.

An interstice is provided between the hammer guide hole 464b and the hammer guide pin A 464h of the hammer 464. It is comprised such that the interstice when the hammer 464 contacts with the hour heart 332d, the second heart 322d and the minute heart 342d becomes larger than the interstice when the hammer 464 is guided by the hammer guide pin A 464h and the hammer guide pin B 464j.

An interstice is provided between the hammer guide part 464c and the hammer guide pin B 464j of the hammer 464. It is comprised such that the interstice when the hammer 464 contacts with the hour heart 332d, the second heart 322d and the minute heart 342d becomes larger than the interstice when the hammer 464 is guided by the hammer guide pin A 464h and the hammer guide pin B 464j.

By this constitution, when the hammer 464 contacts with the hour heart 332d, the second heart 322d and the minute heart 342d, the position of the hammer 464 is surely determined by the three hearts. That is, by the three hearts, it is possible to “self-align” the position of the hammer 464.

Referring to FIG. 33 and FIG. 34, it is good to comprise such that the hour heart contact part 464d and the second heart contact part 464e become parallel. It is preferable to comprise such that an angle formed by the hour heart contact part 464d and the second heart contact part 464e becomes 10 degrees or less.

It is preferable that an angle DTF formed by the hour heart contact part 464d and the minute heart contact part 464f is 80 degrees-100 degrees, and it is more preferable that it is comprised so as to become a right angle (90 degrees). By this constitution, the hammer 464 can simultaneously, surely return the hour heart 332d and the minute heart 342d to zero (hand return).

It is preferable that an angle DLT which is formed with respect to the hour heart contact part 464d by a direction along which the hammer 464 is moved toward the hour heart 332d, the second heart 322d and the minute heart 342d while being guided by the hammer guide pin A 464h and the hammer guide pin B 464j is 30 degrees-60 degrees. When the DLT is 45 degrees, an operation stroke of the hammer 464 becomes minimum. Accordingly, it is especially preferable that the angle DLT is 45 degrees. By this constitution, the hammer 464 can surely return the hour heart 332d, the second heart 322d and the minute heart 342d to zero. It is more preferable that the angle DLT is 45 degrees. By this constitution, the hammer 464 can more surely return the hour heart 332d, the second heart 322d and the minute heart 342d to zero (hand return).

When the reset button 308 is pushed in the direction shown by the arrow mark and the hammer 464 contacts with the hour heart 332d, the second heart 322d and the minute heart 342d, it is preferable that an angle DLC formed with respect to the second heart contact part 464e of the hammer 464 by a direction along which a force is applied to the hammer operation pin 464a is 57 degrees-84 degrees, and it is more preferable that it is 63 degrees-82 degrees. Detailedly analyzing an operation of the hammer 464, when the angle DLC is 63.4 degrees, a force applied to the hour heart 332d by the hammer 464, a force applied to the second heart 322d by the hammer 464 and a force applied to the minute heart 342d by the hammer 464 become the same value. Considering a weight ratio, a moment of inertia ratio and the like of the hand, when the angle DLC is 81.85 degrees, a ratio between [the force applied to the hour heart 332d by the hammer 464 and the force applied to the minute heart 342d by the hammer 464] and [the force applied to the second heart 322d by the hammer 464] becomes 1:5. Accordingly, it is especially preferable that the angle DLC is 63 degrees-82 degrees.

It is supposed that a force applied to the hammer operation pin 464a provided in the hammer 464 by the click spring 418 through the hammer operating lever B 482 is F (refer to FIG. 34). When the angle DLC is 57.2 degrees, the force applied to the second heart 322d by the hammer 464 becomes below 0.3F. Further, when the angle DLC is 84.2 degrees, the force applied to the hour heart 332d by the hammer 464 and the force applied to the minute heart 342d by the hammer 464 become below 0.1F. Accordingly, it is preferable that the angle DLC is 57 degrees −84 degrees.

By this constitution, it is possible to comprised such that a force under which the hammer 464 contacts with the hour heart 332d, a force under which the hammer 464 contacts with the second heart 322d and a force under which the hammer 464 contacts with the minute heart 342d become even.

(10) Explanation of Operation of Chronograph Timepiece

Referring to FIG. 15, under a state that the chronograph mechanism is not operated, the hour hand 368 shows “hour” among the present times, the minute hand 364 shows “minute” among the present times, and a second hand 354 (small second hand) shows “second” among the present times. A chronograph timepiece shown in FIG. 15 displays an intermediate time between “10 o'clock 8 minute 12 second” and “10 o'clock 8 minute 13 second”. Under this state, the chronograph hour hand 338 is stopped at a position indicating “12”, the chronograph minute hand 348 is stopped at a position indicating “30”, and the chronograph second hand 324 is stopped at the 12 o'clock direction of the time piece, i.e., a position indicating “60”.

The chronograph second hand 324 is comprised so as to perform one revolution per one minute. As to a chronograph second graduation corresponding to the chronograph second hand 324, “5”, “10”, “15”, . . . “50”, “55” and “60” are provided along an outer periphery of the timepiece, i.e., along a rotation locus of a tip of the chronograph second hand 324.

As one example, an embodiment of the chronograph timepiece of the invention is comprised so as to become a timepiece of a so-called “8 vibrations”. The “8 vibrations” means a constitution in which a balance with hairspring performs 28800 impulses per one hour. Here, “impulse” shows a state that the balance with hairspring rotates in one direction, and the balance with hairspring returns to its original position by “2 impulses”. That is, in the timepiece of the “8 vibrations”, the balance with hairspring performs eight impulses per one second and vibrates so as to perform four reciprocations per one second. The chronograph timepiece may be comprised so as to become a timepiece of a so-called “10 vibrations”. The “10 vibrations” means a constitution in which the balance with hairspring performs 36000 impulses per one hour. In the timepiece of the “10 vibrations”, the balance with hairspring performs ten impulses per one second and vibrates so as to perform five reciprocations per one second. By constituting in this manner, it is possible to realize a chronograph timepiece capable of performing the chronograph measurement by “1/10 second” unit.

In this constitution, it is good that the chronograph second graduation is provided in every “1/10 second”, or the chronograph second graduation is provided in every “⅕ second”. By constituting in this manner, it is possible to realize a high precision chronograph timepiece. The chronograph timepiece may be comprised so as to become a timepiece of a so-called “5.5 vibrations” or “6 vibrations”. In these constitutions, the chronograph second graduation is set while being agreed with the number of the vibrations, and the teeth number of the train wheel is also set while being agreed with the number of the vibrations.

The chronograph minute hand 348 is comprised so as to perform one revolution per 30 minutes. As to a chronograph minute graduation corresponding to the chronograph minute hand 348, “5”, “10”, “15”, “20”, “25”and “30” are provided along a rotation locus of a tip of the chronograph minute hand 348. The chronograph minute hand 348 may be comprised so as to perform one revolution per 60 minutes.

The chronographhour hand 338 is comprised so as to perform one revolution per 12 hours. As to a chronograph hour graduation corresponding to the chronograph hour hand 338, “1”, “2”, “3” . . . “11” and “12” are provided along a rotation locus of a tip of the chronograph hour hand 338. The chronograph hour hand 338 may be comprised so as to perform one revolution per 24 hours.

A date character of the date indicator 476 displays a date at the present. The chronograph timepiece shown in FIG. 15 displays “5th day”. In FIG. 15, there is shown a structure in which a position of the date window is in a middle between the “4 o'clock direction” and the “5 o'clock direction” of the movement, but the position of the date window can be disposed in the “12 o'clock direction ” of the movement, and can be disposed in other position such as the “1 o'clock direction” and the “8 o'clock direction”.

In the chronograph timepiece of the invention, a rotation center of the hour hand 368, a rotation center of the minute hand 364 and a rotation center of the chronograph second hand 324 are disposed in an approximate center of the timepiece, a rotation center of the second hand 354 (small second hand) is disposed in a 3 o'clock side of the timepiece, a rotation center of the chronograph minute hand 348 is disposed in a 9 o'clock side of the timepiece, and a rotation center of the chronograph hour hand 338 is disposed in a 6 o'clock side of the timepiece. Accordingly, in the chronograph timepiece of the invention, the display of each of the hands is very easy to see.

Referring to FIG. 15 and FIG. 26, it is possible to start the chronograph measurement by pushing the start/stop button 306 existing in the 2 o'clock direction of the chronograph timepiece. That is, if the start/stop button 306 is pushed, the operating lever A 412 and the operating lever B 416 are operated, and the ratchet teeth 424 of the operation cam 420 are fed by one tooth, thereby rotating the operation cam 420. If the operation cam 420 is rotated, the chronograph coupling lever A 444 and the chronograph coupling lever B 446 are separated from the second chronograph intermediate wheel clutch ring 320d, and the hour/minute chronograph coupling lever 442 is separated from the hour chronograph intermediate wheel clutch ring 332h and the minute chronograph intermediate wheel clutch ring 342h, thereby making the clutch ON. As a result, the second chronograph wheel axle 322c is rotated, the minute chronograph wheel axle 342c is rotated, and the hour chronograph wheel axle 332c is rotated. As a result, the chronograph second hand 324 displays “second” of the chronograph measurement result, the chronograph minute hand 348 displays “minute” of the chronograph measurement result, and the chronograph hour hand 338 displays “hour” of the chronograph measurement result.

Next, if the start/stop button 306 is pushed once more, the measurement of the chronograph timepiece can be stopped. That is, if the start/stop button 306 is pushed once more, the operating lever A 412 and the operating lever B 416 are operated, and the ratchet teeth 424 of the operation cam 420 are fed by one tooth, thereby rotating the operation cam 420. If the operation cam 420 is rotated, the chronograph coupling lever A 444 and the chronograph coupling lever B 446 contact with the second chronograph intermediate wheel clutch ring 320d, and the hour/minute chronograph coupling lever 442 contacts with the hour chronograph intermediate wheel clutch ring 332h and the minute chronograph intermediate wheel clutch ring 342h, thereby making the clutch OFF. Further, the operation cam 420 operates the stop lever 440, and the stop lever 440 sets the stop lever plate 322 of the second chronograph wheel 322. As a result, a rotation of the second chronograph wheel axle 322c is stopped, a rotation of the minute chronograph wheel axle 342c is stopped, and a rotation of the hour chronograph wheel axle 332c is stopped. As a result, the chronograph second hand 324 is stopped while displaying “second” of the chronograph measurement result, the chronograph minute hand 348 is stopped while displaying “minute” of the chronograph measurement result, and the chronograph hour hand 338 is stopped while displaying “hour” of the chronograph measurement result.

Under this state, if the start/stop button 306 is pushed once further, it is possible to further restart the chronograph measurement from a state that the chronograph measurement has been stopped.

Referring to FIG. 15 and FIG. 35, under that state that the chronograph measurement has been stopped, if the reset button 308 is pushed, the chronograph second hand 324, the chronograph minute hand 348 and the chronograph hour hand 338 are stopped while returning to “zero position” before an operation start of the chronograph mechanism. That is, if the reset button 308 is pushed, the hammer operating lever A 480, the hammer operating lever B 482 and the hammer 464 are operated. Additionally, the hammer operating lever A 480 rotates the stop lever 440, and the setting part 452c of the stop lever body 452 is separated from the stop lever plate 322f, thereby making the second chronograph wheel 322 a free state. And, the hammer 464 rotates the second heart 322d, rotates the minute heart 342d and rotates the hour heart 332d, thereby returning the chronograph second hand 324, the chronograph minute hand 348 and the chronograph hour hand 338 to “zero position”.

Also during the chronograph measurement and also under the state that the chronograph measurement has been stopped, the hour hand 368 is showing “hour” among the present times, the minute hand 364 is showing “minute” among the present times, and the second hand 354 is showing “second” among the present times.

Referring to FIG. 5, FIG. 6 and FIG. 15, by drawing out a crown 390, the winding stem 108 can be drawn out. By drawing out the winding stem 108 to the 1st step and rotating the crown 390, a date correction can be performed by rotating the winding stem 108. By drawing out the winding stem 108 to the 2nd step and rotating the crown 390, a time correction can be performed by rotating the winding stem 108.

In the chronograph timepiece of the invention, since a clutch mechanism is not provided in the front train wheel, the structure of the chronograph train wheel is simple, and the number of parts is small.

With the chronograph timepiece of the invention, the manufacture and the assembly of the chronograph mechanism are easy.

What is claimed is:

1. A chronograph timepiece in which a mainspring provided in amovement barrel complete is made a power source, comprising:
a base unit containing a main plate constituting a base plate of a movement, a front train wheel rotating on the basis of a rotation of a movement barrel complete and an escapement/speed control device for controlling a rotation of the front train wheel, and having at least one of a self-winding device or a hand winding device, and
a chronograph unit containing a second display mechanism, a second chronograph train wheel, a minute chronograph train wheel and an hour chronograph train wheel,
wherein the chronograph unit is disposed in a side where a dial exists than the base unit,
the base unit contains a 1st transmission wheel and a 2nd transmission wheel, which are rotated on the basis of a rotation of the movement barrel complete,
wherein the second chronograph train wheel is comprised so as to be rotated on the basis of a rotation of the 1st transmission wheel,
the minute chronograph train wheel and the hour chronograph train wheel are comprised so as to be rotated on the basis of a rotation of the 2nd transmission wheel,
the hour chronograph train wheel contains an hour chronograph wheel,
the minute chronograph train wheel contains a minute chronograph wheel,
the second chronograph train wheel contains a second chronograph wheel, and
“hour” of a chronograph measurement result is displayed by a chronograph hour hand attached to the hour chronograph wheel,
wherein “minute” of the chronograph measurement result is displayed by a chronograph minute hand attached to the minute chronograph wheel, and
“second” of the chronograph measurement result is displayed by a chronograph second hand attached to the second chronograph wheel.

2. A chronograph timepiece set forth in claim 1,
whrein the 1st transmission wheel is a second wheel & pinion rotated on the basis of the rotation of the movement barrel complete,
the second chronograph train wheel is comprised so as to be rotated on the basis of a rotation of the second wheel & pinion,
the 2nd transmission wheel is a minute driving wheel & pinion rotated on the basis of the rotation of the movement barrel complete, and
the minute chronograph train wheel and the hour chronograph train wheel are comprised so as to be rotated on the basis of a rotation of the minute driving wheel & pinion.

3. A chronograph timepiece set forth in claim 2,
wherein the minute driving wheel & pinion contains a cannon pinion,
a 2nd minute wheel is comprised so as to be rotated on the basis of a rotation of the cannon pinion,
the minute chronograph wheel and the hour chronograph wheel are comprised so as to be rotated on the basis of a rotation of the 2nd minute wheel.

4. A chronograph timepiece set forth in claim 3, comrising:
a date indicator for performing a calendar display,;
wherein the date indicator is comprised so as to be rotated on the basis of the rotation of the 2nd minute wheel.
